(19) United States
(12) Patent Application Publication
(10) Pub. No.: US 2006/0271412 A1
(43) Pub. Date: Nov. 30, 2006

(54) Healthcare transaction system and method for automated healthcare claim resolution and workflow management

(76) Inventors: James W. Sohr, Nashville, TN (US); Steven J. Yurjevich, Franklin, TN (US); Darby W. Brown, Belle Mende, TN (US); Matthew M. Corzine, Franklin, TN (US)

Correspondence Address: John H. Thomas, P.C., 536 Granite Avenue, Richmond, VA, 23226, US

(21) Appl. No.: 11/140,216

(22) Filed: May 27, 2005

(51) Int. Cl. G06Q 40/00; G06F 15/02

(52) U.S. Cl. 705/4; 705/9

(57) ABSTRACT

A scalable healthcare claim resolution and workflow management system is provided which resolves healthcare claim discrepancies and disputes among multiple healthcare payers and providers. The system can also be used to communicate and track claims within a single organization. The claim resolution system facilitates communication between parties while maintaining an inventory and tracking claim disputes within the system. The system standardizes the inefficient and disparate systems found in the art.

### FIELD OF THE INVENTION

The present invention relates generally to a healthcare transaction system and method for healthcare claim resolutions. More specifically, it relates to a scalable healthcare claim resolution and workflow management system that facilitates the resolution of healthcare claim discrepancies and disputes among multiple healthcare payers and providers.

### DESCRIPTION OF THE RELATED ART

It can be appreciated that pre-payment automated claim processing portals have been in use for years. Claim processing portals are comprised of a wide variety of automated systems in the pre-payment arena. Typically, a healthcare provider generates a medical claim on the provider's system and submits the claim to a payer for processing and payment from the payer's system. The pre-payment billing process just described is often partially automated by way of an electronic billing process, which allows a paperless automated submittal of the claim from the provider's system to the payer's system. The processing and payment of the claim is often automated as well. For example, a large percentage of claims are adjudicated or approved for payment with limited or even no human intervention. The payment of a claim has also been automated in many cases with electronic remittances and wired funds delivered based on the protocols established between some payers and providers. However, such systems fail to address the myriad of problems that are routinely encountered in the healthcare payment arena after the medical claim has already been paid. In other words, the current technology focuses on pre-payment activities, but fails to address, and is incapable of addressing, the multitude of problems arising post-payment.

One significant problem with conventional claim processing portals is that when payment of a healthcare claim is received by a healthcare provider from a healthcare payer, oftentimes the payment is later determined, for various reasons, by either the provider or payer, to have been incorrect. For example, the claim may have been overpaid, underpaid, incorrectly denied, incorrectly billed, incorrectly posted or paid twice. It is estimated that these types of claims may represent in excess of twenty percent of all post-care claims. There are additional reasons why the payment might be incorrect or improper, but in each case the administrative cost incurred by both parties to resolve these incorrectly paid claims is significant and raises the cost of healthcare for all Americans.

The problems encountered during the claim resolution process are exacerbated due to the fact that the process itself is disjointed and inconsistent between not only the different payer and provider groups but also within the same payer or provider group. Such an inconsistent and disjointed claims resolution process contributes to the inevitable scenario whereby a number of claims may be left unresolved for many months or even years or whereby claims are mired in an undocumented and inconsistent process until the claim is either forgotten altogether or resolved. Another problem with conventional claim processing systems are that healthcare payers and providers track and resolve claims on disparate computer and software and thus lack the ability to communicate with one another using a common data set. Post-payment claim resolution communication is, for the most part, achieved through telephone, facsimile, mail or electronic mail. Communication through the above-referenced media fails to allow common or shared payment or claim level tracking. Because providers and payers track and resolve healthcare payment claims on disparate systems, claim level tracking is extremely time consuming and expensive. Moreover, because some systems were designed to bill claims and other systems were designed to pay claims, neither system is adequately equipped to create the tracking, reporting and work flow processes necessary to quickly and inexpensively resolve incorrectly paid claims.

Even if such disparate systems could resolve incorrectly paid claims, because the systems function independently, with different information being utilized to arrive at separate, subjective and biased conclusions, oftentimes the “ping-pong” effect occurs. This effect entails healthcare providers and payers bouncing financial transactions back and forth without making progress toward claims resolution. Each transaction has an associated cost, meaning healthcare costs are driven higher with each “volley.” The repeated exchange of financial transactions for a particular claim occurs for many reasons, including a failure to communicate between the parties, a lack of knowledge by at least one of the parties involved, and/or the failure to include certain information required for the other party to identify and properly record the financial transaction adjustment into a given system. Further complicating claims resolution in the current environment is the fact that three versions of any claim may exist, one at the payer, one at the provider, and one at the electronic claims clearinghouse. These scenarios are a natural consequence of a manual resolution process and contributes to a disjointed and inconsistent resolution process which results in huge inefficiencies and excessive, but avoidable, administrative costs.

These inefficiencies are graphically captured in FIGS. 1-17, which are discussed in more depth below. The illustrated flowcharts provide graphical examples of what current post-payment claims processing entails, and they also highlight representative problems that may occur during claims processing. FIG. 1, for instance, shows the circumstance where a payer has identified an overpayment and attempts to contact a provider. The payer calls, writes or faxes a provider. If the contact fails or the provider does not acknowledge the request, the payer renews their inquiry. This is typically carried out for up to 120 days before the matter is referred to a collections agency. If the request is acknowledged by a target date, the provider may still request additional information, further lengthening the time to resolution (See FIG. 2). The prior art figures only capture examples of prior art methods. The figures are thought to be helpful or necessary in understanding the applicant's invention and how it improves upon the prior art techniques.

Claims processing portals are not suitable for post-payment, post-adjudication healthcare claim resolution, or for resolving healthcare claim discrepancies and disputes among multiple healthcare payers and providers. For example, even if a provider were able to use a payer-established portal to notify the payer of a problem claim, such a portal would fail to allow ongoing tracking, verification, or confirmation.

Therefore, there exists a need for a claim resolution system that can expedite the resolution of problem claims while bringing corporate and individual accountability to the resolution process. It is preferred that such a system would allow payers and providers to communicate and benefit from access to a common set of facts from which they can mutually investigate, draw conclusions, track and resolve claims before a final financial resolution takes place. A scalable, automated healthcare claim resolution and workflow management system in accordance with the present invention allows healthcare claim discrepancies and disputes to be resolved, even among multiple healthcare payers and providers. As described below, the present invention substantially departs from the conventional concepts, methods and designs of the prior art, and it provides an original apparatus and/or method for improving the post-payment, post-adjudication healthcare claim resolution process.

### SUMMARY OF THE INVENTION

In accordance with the present invention, a scalable, automated healthcare claim resolution and workflow management system is provided that resolves healthcare claim discrepancies and disputes among and between healthcare payers and providers. A claim is considered a request between a payer and provider intended to resolve a financial balance concerning a patient's account. The system resolves healthcare claims in a post-payment and/or post-adjudication environment, among multiple healthcare payers and providers. In an envisioned embodiment the system can also be used to answer questions about a pre-adjudicated or processed claim to document and resolve issues before the claim is paid, preventing future discrepancies. The claim resolution process is automated by way of an electronic portal that is accessible by one or more of the participants to the dispute. The portal provides a potentially paperless automated resolution of the dispute.

As a claims processing portal, the present invention presents many advantages and features that result in a new methodology for scaling and automating post-payment, post-adjudication healthcare claims scenarios that will overcome a number of shortcomings recognized in the prior art. The subject resolution system may be used to resolve healthcare claim discrepancies and disputes among multiple healthcare payers and providers, and it allows multiple healthcare providers, payers, insurance companies, carriers, Health Maintenance Organizations (‘HMOs’), Independent Physician Associations (‘IPAs’), government entities, self-insured companies, Third Party Administrators (‘TPAs’), and other authorized entities to participate in a pre- or post-payment financial reconciliation process related to medical claims. The present invention allows these entities to view and work from a common set of facts, to communicate quickly (e.g., in real time), and to take the steps necessary to resolve a financial transaction issue concurrently.

The resolution system functions as an unbiased transaction platform that operates as a common and shared intermediary system between multiple payer and multiple provider platforms. The information technology (IT) infrastructure components required to support the present system are known in the art and include, for example, personal computer hardware and peripherals, an operating system(s), and data storage and networking components. The IT architecture can be scaled by adding known items such as, but not limited to, web servers, application servers, and data storage components as required. A scalable infrastructure provides the ability to evolve the infrastructure as needed to support additional users or an increase in the load on servers resulting form additional programs and functionality (and vice-versa).

The system maintains a database of claims processing rules, and other information that is extracted from one or more providers, payers, and other entities in order to streamline and improve the workflow process. When the claim dispute is generated or referred, it is placed within a claims dispute inventory and an electronic work queue is generated. Significantly, the system is structured to allow a payer and a provider to resolve a problem claim using a shared and common set of data that may be modified or appended by either party. In a preferred embodiment, each modification or action taken by a party is shared with the other party to maintain a consistent understanding of the claim and each party has simultaneous access to the modifications.

The resolution system also functions as a workflow management system, healthcare claim tracking system, real time provider and payer communication system, and as a financial transaction reconciliation system. The system equally benefits both the healthcare provider and the healthcare payer in that it provides a post-payment analysis of all categories of disputed healthcare claims in the same manner, whether the claim is underpaid, denied, incorrectly paid, incorrectly posted, overpaid, or the like. Unlike current systems, which serve the needs of either the payer or the provider, and hence contribute to disputes that are difficult to resolve as the parties are not working with the same information, the present invention maintains common or shared billing/payment claim-level tracking. Because the present invention allows providers and payers to track and resolve healthcare payment claims on the same system, with a commonly built and shared claim history, claim level tracking is less time consuming and less expensive. Therefore, the invention will allow for the earlier identification of root cause problems related to healthcare claims payment and will facilitate the correction of these problems. Moreover, although the present invention has the ability to communicate with front-end billing or claims processing system functions, the present invention also has the ability to function without the necessity of having to communicate with such systems.

The system of the present invention also provides for customized data requirements or field requirements at the user and/or payer and provider level. The system has standardized a processing system for in-house, bilateral or multilateral processing systems, and it maintains the flexibility to accommodate specific needs and requests on a case-by-case, individualized basis. Input and output of data, reports and information have the ability to accommodate requests lodged in any medium. When customized data or a field requirement is needed, the system allows for these to be added infinitely on an individual basis for the payer or provider.

In order to facilitate communication and knowledge sharing, the present invention automatically notifies an entity when another user has requested its participation on a claim or claims. Payers, providers and other authorized users are able to initiate transaction requests to other participating users. The system meets or exceeds all current state and federally mandated transaction requirements, including, but not limited to, those requirements set forth pursuant to the Health Insurance Portability and Accountability Act of 1996 (‘HIPAA’). It is envisioned that the system could be modified to conform to future statutory requirements.

The resolution system allows for other operational measurements and improvements in customer service and government compliance through more informative tracking. The age of a claim dispute from origination to resolution can be tracked by stamping the claim dispute record. The modified values of the claim settlement can be tracked for training and forecasting purposes.

A method of using the system to resolve healthcare claims first includes providing an electronic portal to be accessed by at least a first end user. A claim originator refers a claim dispute to be viewed as a claim dispute record via the portal. The system maintains a secure private environment for communication between any claim resolution participants and for accessing the portal. The claim dispute record and end user communication is transmitted between parties via the electronic portal. A database stores or tracks the parties' communication, including any actions, progress, or the like, in the claim record. In a preferred embodiment, tracking the dispute record allows each party to view a complete history of the claim dispute record.

Other functions, advantages or features of the present invention will become obvious to the reader and it is intended that such items fall within the scope of the present invention. To the accomplishment of the above and related functions, advantages or features, this invention may be embodied in the form illustrated in the accompanying drawings, attention being called to the fact, however, that the drawings are only illustrative. Changes may be made in the specific construction as illustrated without leaving the scope of the invention. While the above outlines highlights particular features of the invention in order that the detailed description thereof may be better understood, and in order that the present contribution to the art may be better appreciated, there are additional features of the invention that will be described hereinafter. Also, it is to be understood that the phraseology and terminology employed herein are for the purpose of the description and should not be regarded as limiting.

### BRIEF DESCRIPTION OF THE DRAWINGS

Various other objects, features and attendant advantages of the present invention will become fully appreciated as the same becomes better understood when considered in conjunction with the accompanying drawings wherein:

FIG. 1 is a flowchart depicting a typical process in which a payer identifies an overpaid claim and refers the claim to a provider for reimbursement.

FIG. 2 is a flowchart depicting a typical process in which a provider acknowledges a refund request from a payer on an overpaid claim and requests additional information for consideration.

FIG. 3 is a flowchart depicting a typical process in which a provider approves or denies a refund request with or without additional information from a payer.

FIG. 4 is a flowchart depicting a typical process in which a provider agrees to a refund request and sends a bulk check for multiple claims to a payer.

FIG. 5 is a flowchart depicting a typical process in which a provider does not respond to a payer's refund request and/or the account is not resolved and is referred to a primary and/or secondary collection agency for resolution.

FIG. 6 is a flowchart depicting a typical process in which payer identified overpayments are retracted from future payments to a provider.

FIG. 7 is a flowchart depicting a typical process in which a provider of service identifies an overpaid claim and sends notification to a payer.

FIG. 8 is a flowchart depicting a typical process in which a payer receives notice of an overpaid claim and requests additional information.

FIG. 9 is a flowchart depicting a typical process in which a provider of service identifies an overpaid claim and sends payment to a payer for acceptance.

FIG. 10 is a flowchart depicting a typical process in which a payer receives and returns payment on a provider identified overpayment due to lack of information from the provider.

FIG. 11 is a flowchart depicting a typical process in which a provider of service identifies an underpaid claim and refers the claim to a responsible payer for reimbursement.

FIG. 12 is a flowchart depicting a typical process in which a payer acknowledges an additional payment request from a provider on an underpaid claim and requests additional information for consideration.

FIG. 13 is a flowchart depicting a typical process in which a payer approves or denies an additional payment request with or without additional information from a provider.

FIG. 14 is a flowchart depicting a typical process in which a payer agrees to an additional payment request and re-adjudicates the original claim in an effort to correct the underpayment.

FIG. 15 is a flowchart depicting a typical process in which a payer does not respond to the provider's refund request and/or the account is not resolved and is referred to a primary and/or secondary collection agency for resolution.

FIG. 16 is a flowchart depicting a typical process in which a provider manages the internal workflow process related to errant claims resolution.

FIG. 17 is a flowchart depicting a typical process in which a payer manages the internal workflow process related to errant claims resolution.

FIG. 18 is a global view in which a portal is in bi-directional communication with a number of required or optional parties acting on a claim dispute and a database, in accordance with the present invention.

FIG. 19 is a diagrammatic representation of a database infrastructure in support of the portal of the present invention.

FIG. 20 is a flowchart depicting a process in which a payer identifies an overpaid claim and submits the claim with all supporting documentation and attachments to the provider to begin an electronic conversation in regards to the referred accounts via the present invention.

FIG. 21 is a flowchart depicting the process in which a provider agrees to a payer's overpayment request and approves a payment or retraction from future payments via the present invention.

FIG. 22 is a flowchart depicting the process in which a provider and payer communicate regarding the denial of a requested overpayment claim and where a third party may intervene to assist in mediating the disputed claim via a claim portal in accordance with the present invention.

FIG. 23 is a flowchart depicting the process in which a provider of service identifies an overpaid claim and submits the claim with all supporting documentation and attachments to a payer to begin an electronic conversation in regards to the referred accounts via the present invention.

FIG. 24 is a flowchart depicting the process in which a payer agrees to accept a provider-identified overpayment by cash transaction or retraction from future payments or provides detailed information with supporting documents to uphold the original payment via the present invention.

FIG. 25 is a flowchart depicting the process in which a provider of service identifies an underpaid claim and refers the claim to a responsible payer with all supporting documentation to the payer via the present invention.

FIG. 26 is a flowchart depicting the process in which a payer reviews any underpaid claim requests with all supporting claim information and communicates acceptance or denial via the present invention.

FIG. 27 is a flowchart depicting the process in which a provider manages the internal workflow process related to errant claim resolution via the present invention.

FIG. 28 is a flowchart depicting the process in which a payer manages the internal workflow process related to errant claim resolution via the present invention.

FIG. 29 is a block diagram depicting the resolution process of the present invention in comparison to a typical prior art resolution process.

FIG. 30 is a legend defining the illustrated elements in FIGS. 30-35.

FIG. 31 is a schematic diagram further illustrating the elements of the automated healthcare claim resolution and workflow management system of the present invention.

FIG. 32 is a schematic diagram further illustrating the elements of the automated healthcare claim resolution and workflow management system of the present invention.

FIG. 33 is a schematic diagram further illustrating the elements of the automated healthcare claim resolution and workflow management system of the present invention.

FIG. 34 is a schematic diagram further illustrating the elements of the automated healthcare claim resolution and workflow management system of the present invention.

FIG. 35 is a schematic diagram further illustrating the elements of the automated healthcare claim resolution and workflow management system of the present invention.

FIG. 36 is a schematic diagram further illustrating the elements of the automated healthcare claim resolution and workflow management system of the present invention.

### DETAILED DESCRIPTION OF THE INVENTION

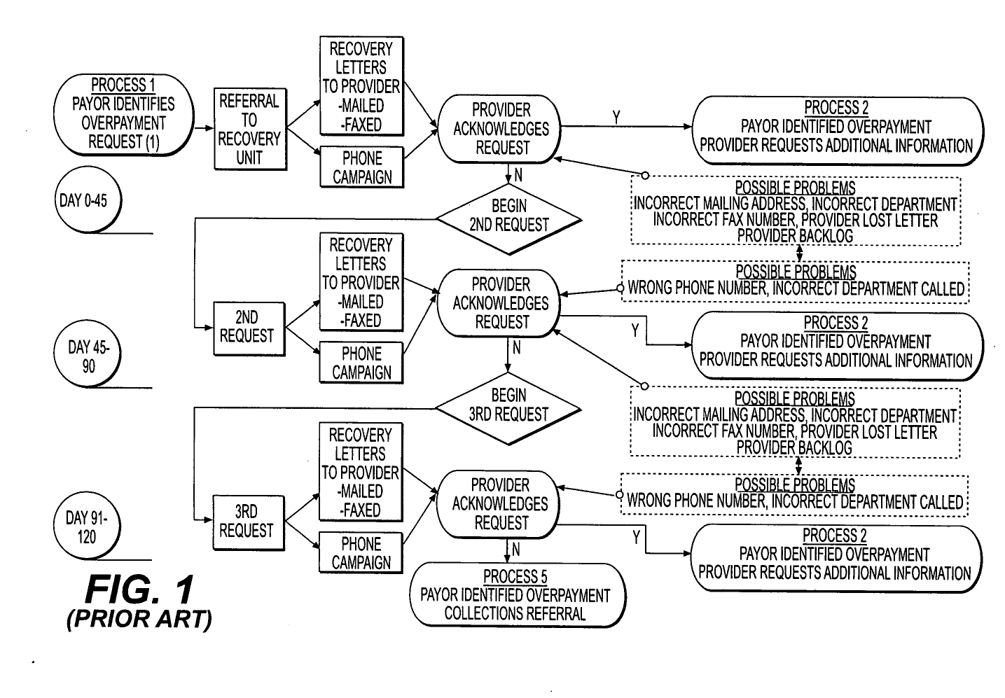

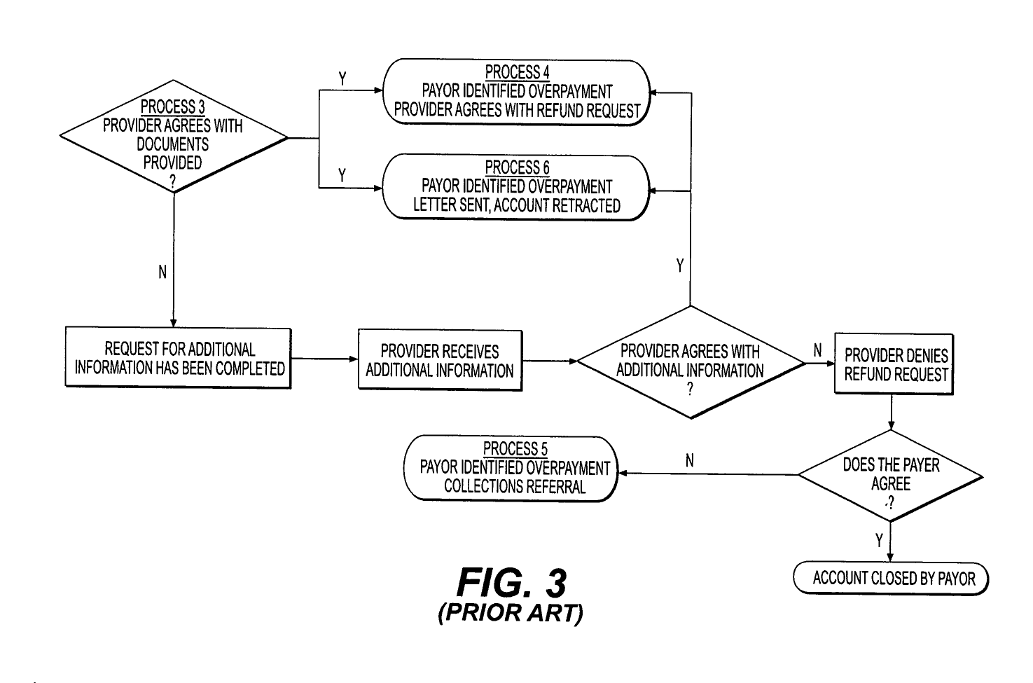

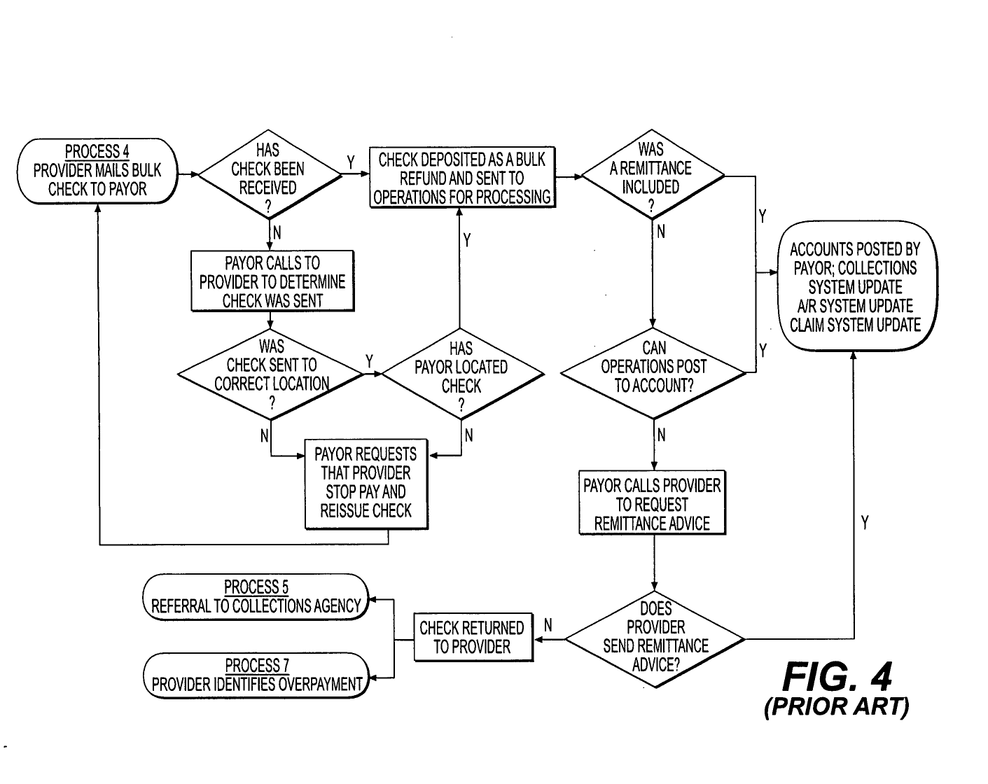

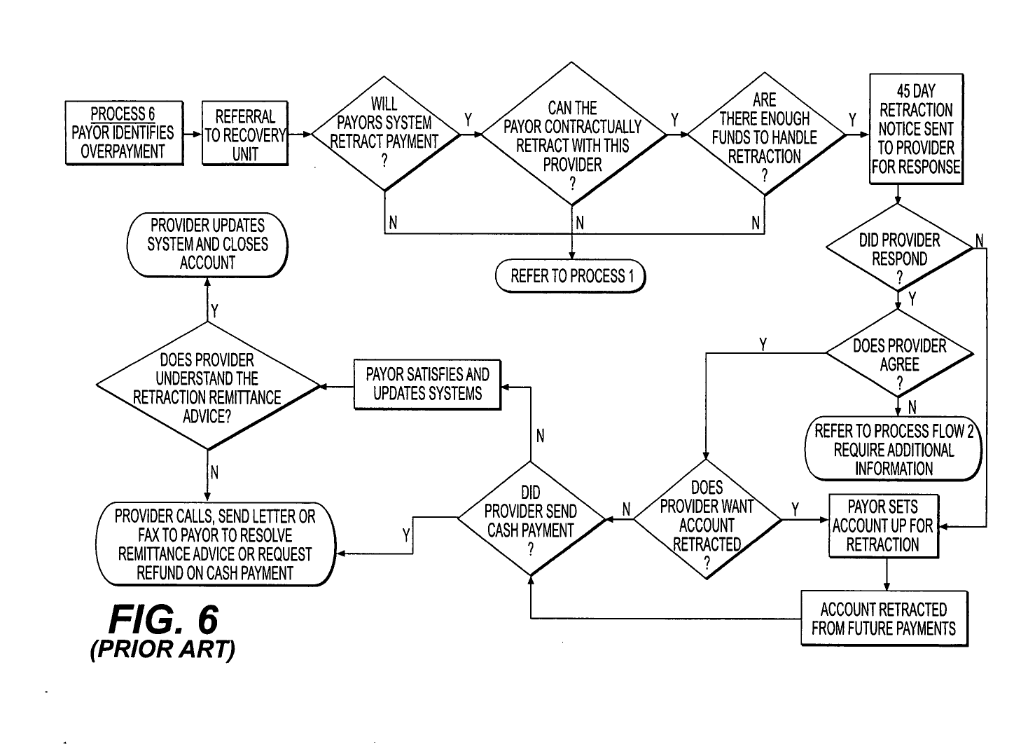

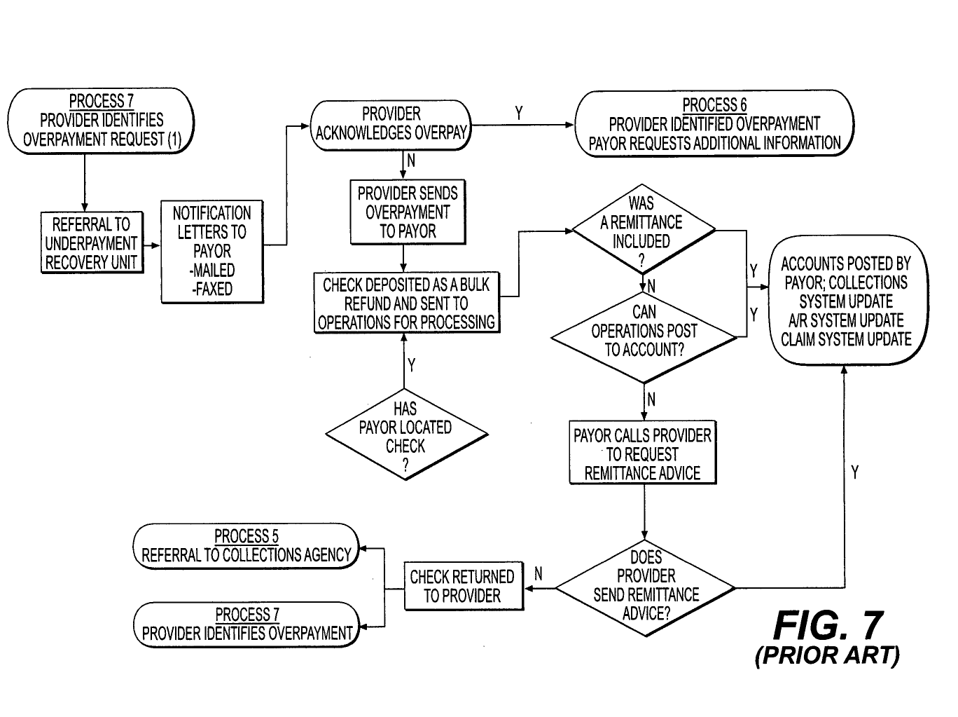

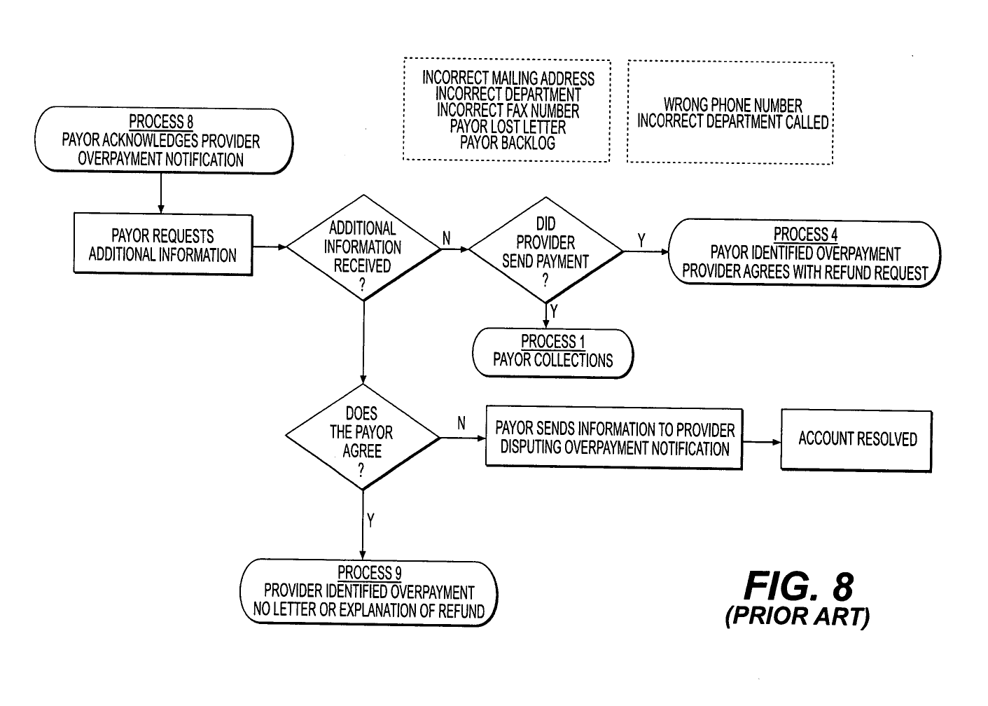

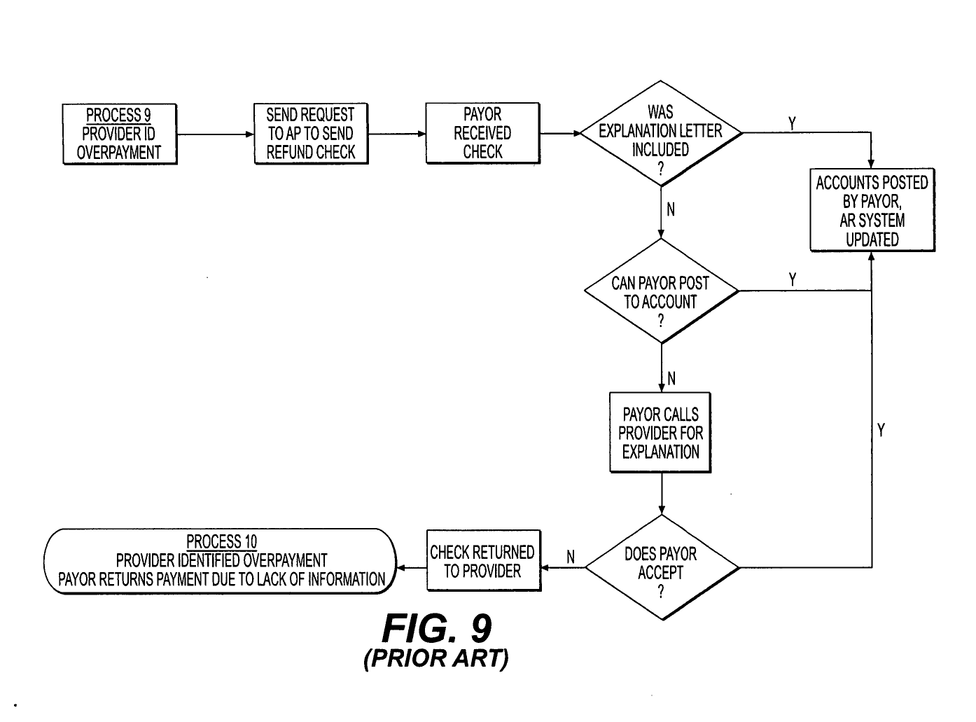

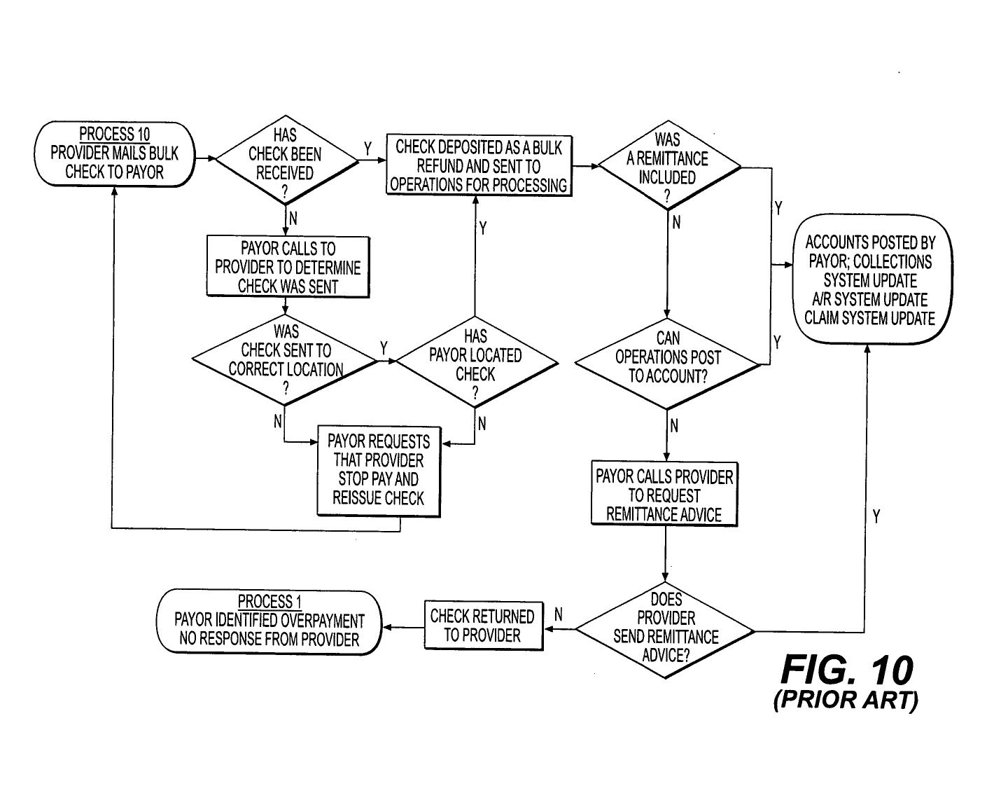

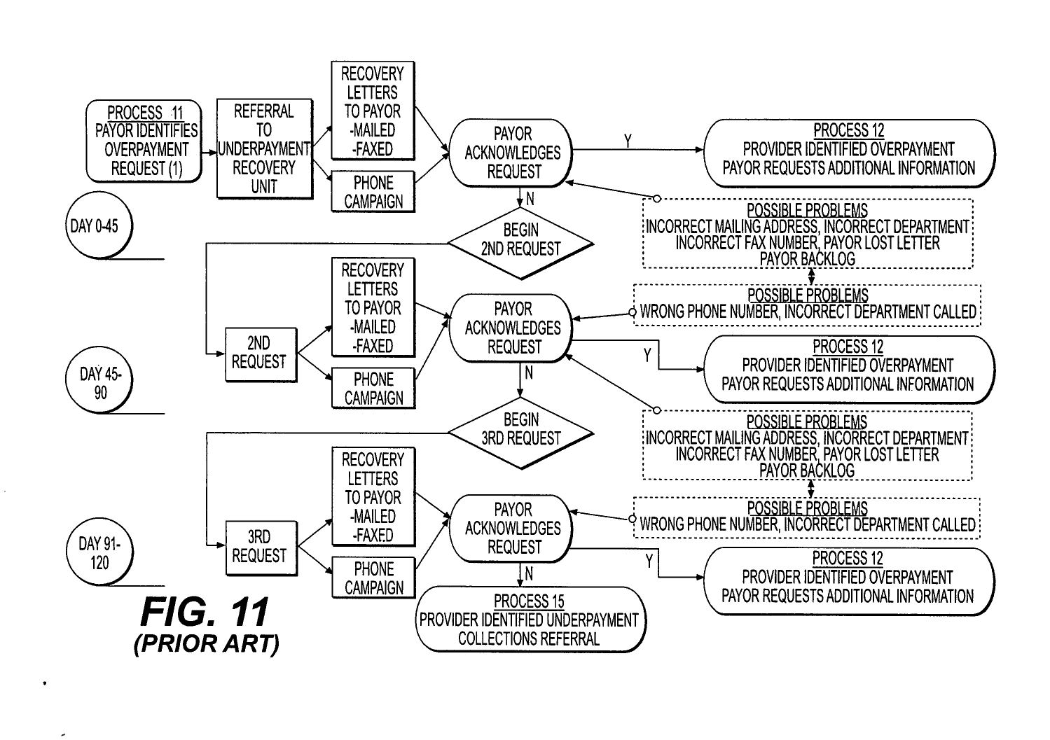

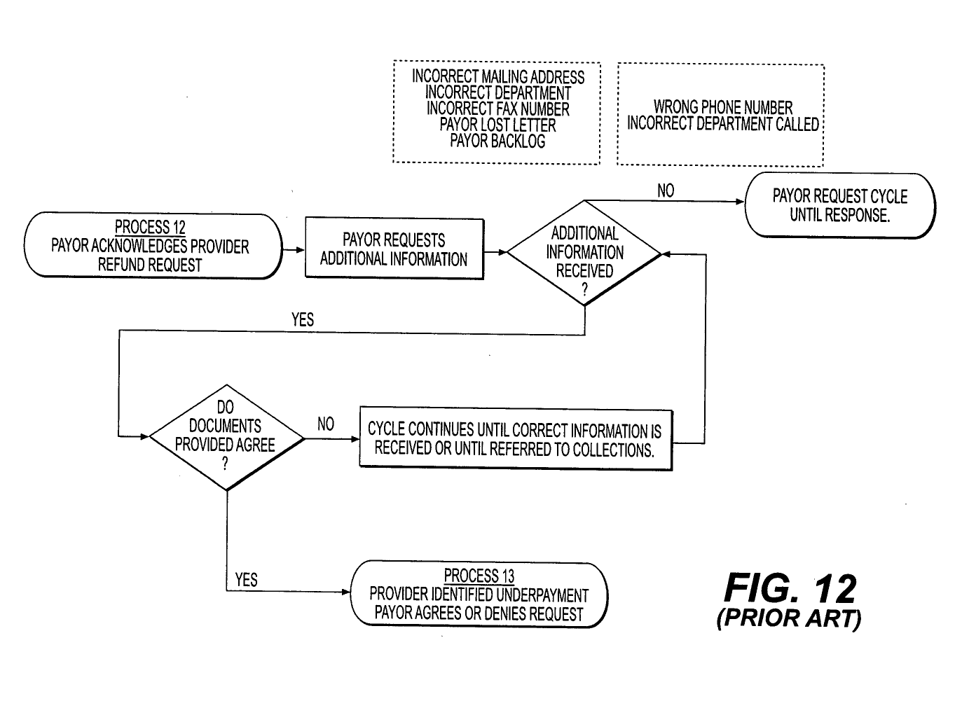

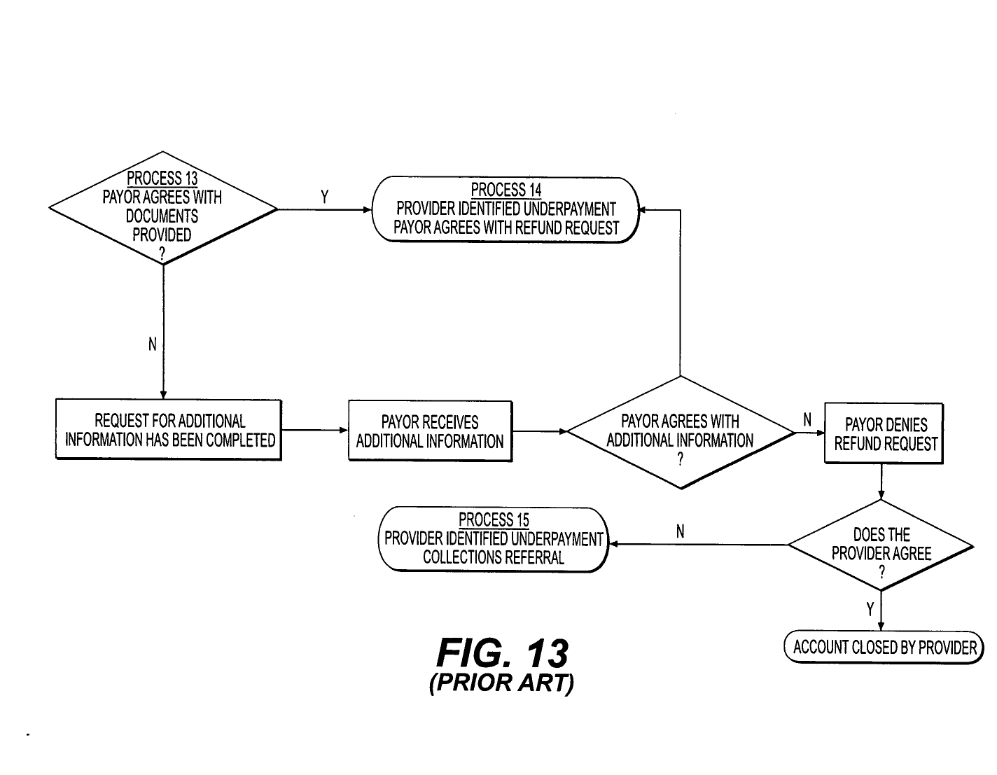

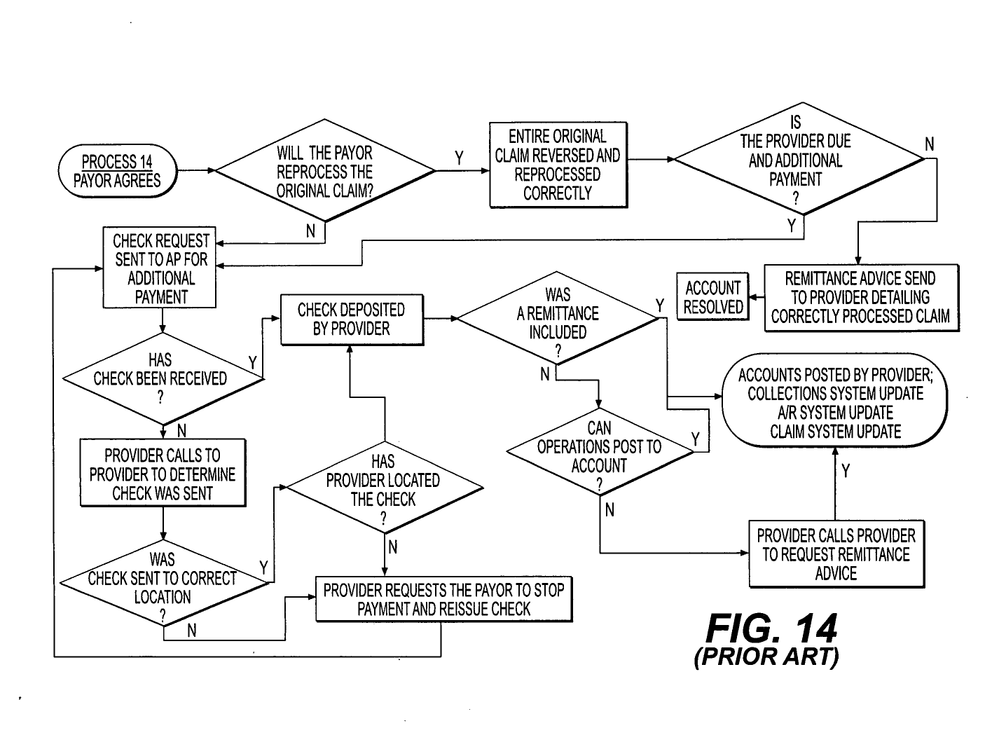

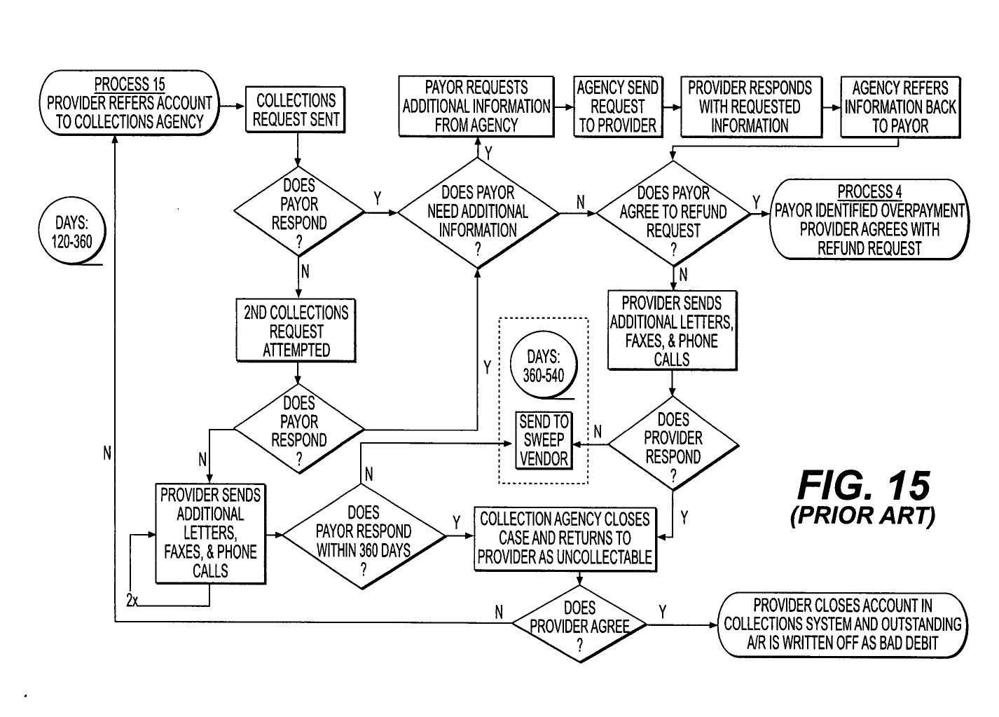

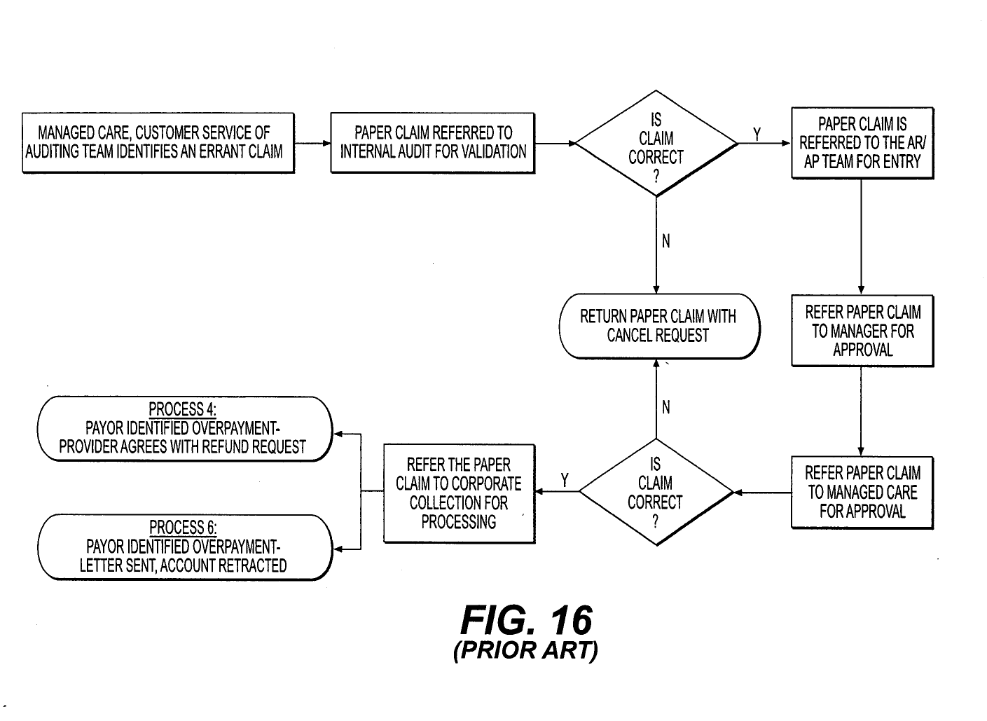

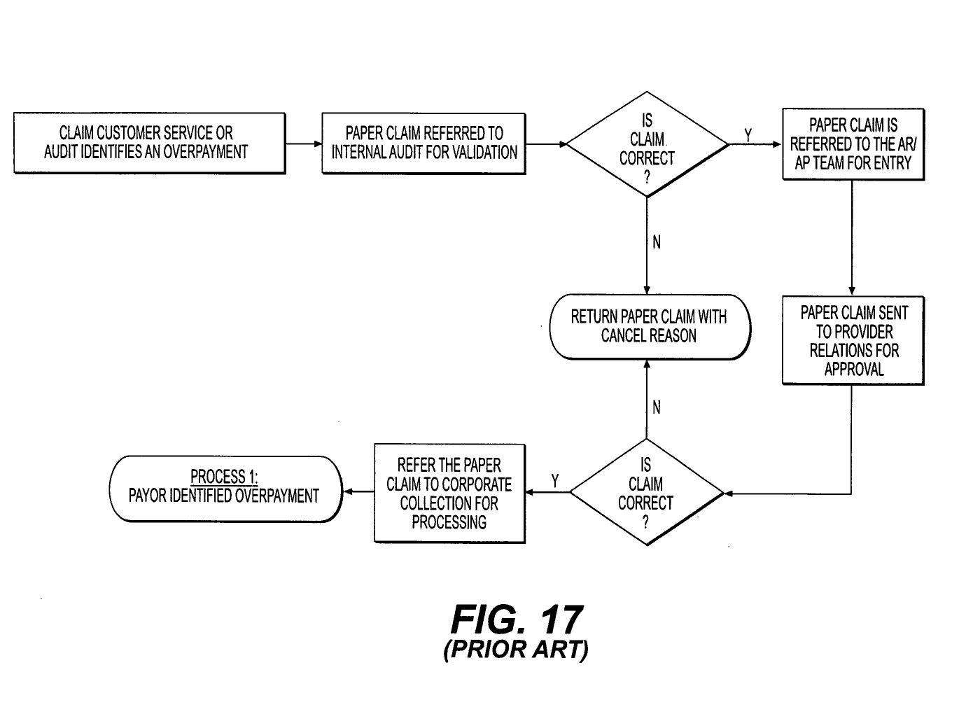

Turning now to a more detailed description of the present invention, there is first illustrated in FIGS. 1-17 embodiments of known post-adjudication, post-payment claim resolution processes that are necessary and helpful in understanding the present invention. The exact and full methodologies for this type of manual claim resolution need not be described in extensive detail herein inasmuch as such in-depth details are known to those skilled in the art, and the details are evident given the illustrations. Moreover, the processes illustrated by flowchart in FIGS. 1-17 are merely exemplary. The present invention provides a system that simplifies and improves upon a wide-range of prior art transactions and need not be strictly associated with the illustrated prior art embodiments.

FIGS. 1-17, being known techniques for resolving post-payment claims, are thought to be self-explanatory. Essentially, each flowchart begins with a broad process step, which is a distinct function or area of activity in the life-cycle of a claim. The party initiating the first process step, the originator, takes the first action, such as contacting one or more additional parties or creating a record of the claim. The receiving party or parties can be located internally within the first party's organization or may be located externally. An action within a process is considered to be a decision made by any person or organization participating in the process that, when enacted on a claim, impacts the life-cycle of the claim by retaining the claim within the current process, triggering additional review and response, or progressing the claim to a new action or process step.

The initiating actions in each process generally involve requests, inquires, or the like related to improper or incorrect payments, requests for more information, or answers/responses to prior process steps or actions. The receiving party or parties may acknowledge the action, fail or decline to acknowledge the action, or make a decision regarding a submitted request or inquiry. The receiver's response is also considered an action within the process step, as defined above.

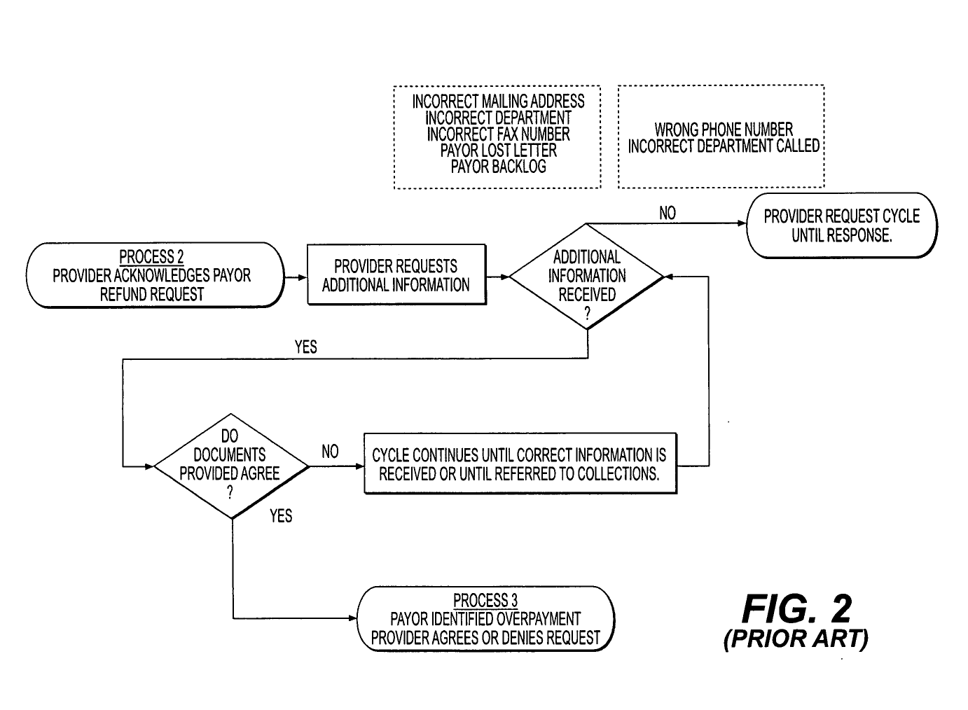

Using FIG. 1 as a representative example, there is illustrated the process step wherein a payer identifies that an overpayment has been made. The matter is sent internally to the payer's recovery unit. The recovery unit's first action entails contacting the appropriate provider(s). Using known communication methods, a payer typically sends to a provider a record of the dispute via U.S. mail, fax machine, or by phone. The provider(s) will either acknowledge the request or will not respond. If the request is acknowledged, a second process step is initiated which generally involves a request for more information (see Process 2 illustrated in FIG. 2). However, where the provider does not acknowledge the request, the payer must generate a second request following a period of time. Therefore, if the payer's request is improperly addressed (i.e., the payer designates the wrong street address, department, fax number, etc), the request is lost or ignored, or the provider does not respond for any other reason, a second request must be generated after a reasonable period of time has lapsed. The second request is generally sent about 45-90 days after the overpayment was referred to the payer's recovery unit.

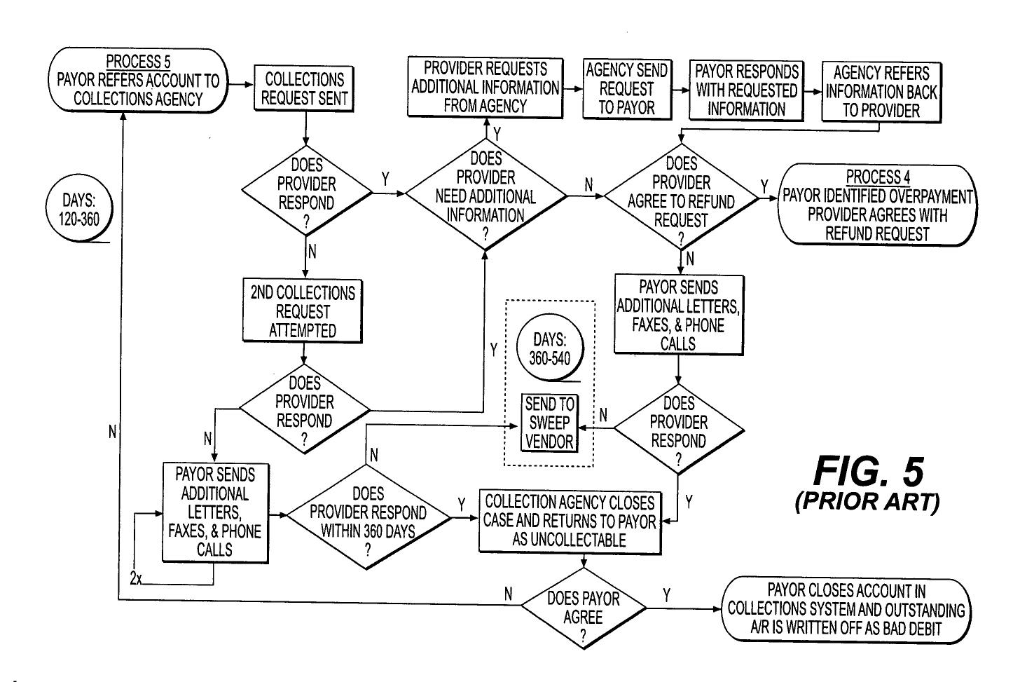

The same options exist for the second request as for the first. As one skilled in the art can surmise from the flowchart, the request process can be carried out indefinitely. However, should the process extend to another request, the third request is generally followed by referring the claim overpayment to a collections agency. At that point, the first process step is generally between 90-120 days old. The collections referral process step is illustrated in FIG. 5, which further details the time period and delays that occur during the collections referral, as well as the potential process steps to follow. The claim dispute progresses or loops through the process steps until the claim is reconciled, denied, closed prematurely by one party before being resolved, or is otherwise closed.

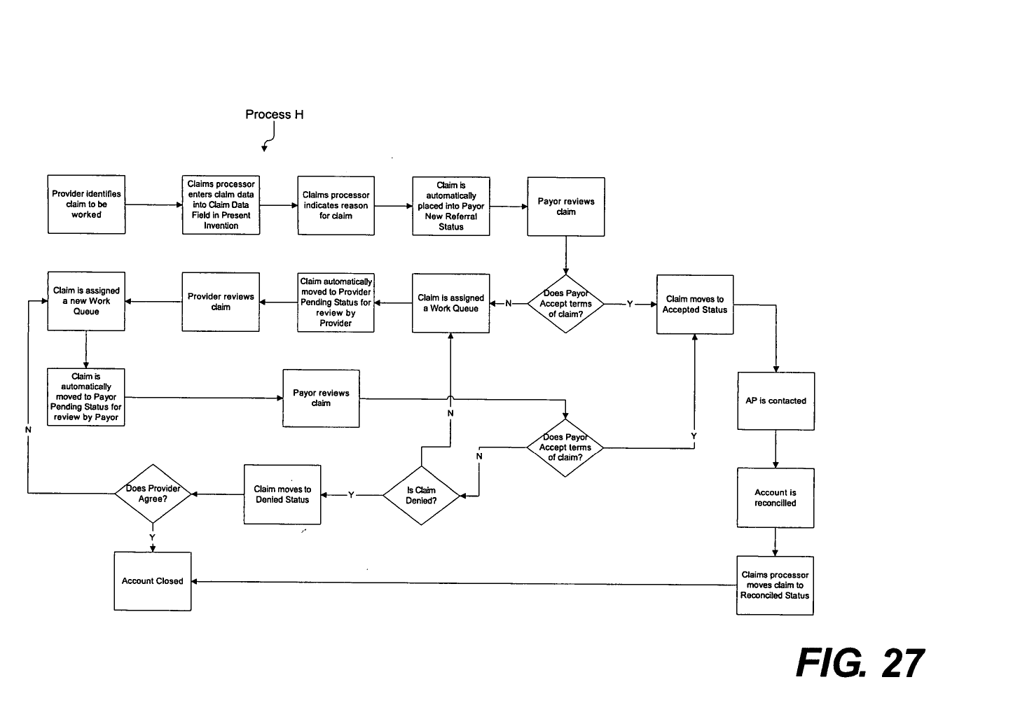

Overall, the self-explanatory flowcharts of FIGS. 1-17 detail the inefficiencies and potential stoppage points in a traditional claim reconciliation system. A number of process steps are illustrated in order to understand the refined process and system of the present invention. These steps do not require further discussion here. FIG. 27 (discussed further below) compares the inefficiencies of the known techniques to the system of the present invention.

The resolution system of the present invention essentially moves the reconciliation of a claim within an electronic environment through four stages: referral, acceptance, agreement and reconciliation. The stages can be defined numerous ways, but the stage of the claim results in a status assignment in the claim record. Payers and providers initially implement the system by defining the specific data requirements, personnel, or other issues required to support the reconciliation process for their respective organizations. This customized configuration within the system allows the users to share system data over multiple and disparate in-house computer systems effectively providing a centralizing and standardizing mode of communication. In other words, multiple parties interact within a shared portal. Data, actions, identifying information and the like are stored in a database that is accessible via the portal. Customization of the system also extends to aesthetics as each user can be presented with a different electronic display or view of information stored in the database. The view is determined by a user-defined profile, a user's role in an organization, or other criteria. View customization is generally known to one skilled in the art in relation to internet web sites, software interfaces, graphical user interfaces, and the like.

For the purpose of the following description of the invention, an originator will be considered the end user associated with either a payer or provider who initiates or refers new claims. A recipient will then be the end-user who is assigned, either automatically by the system or manually by a supervisor, to review a claim submitted by the originator. The originator has the ability to request a specific type of settlement and a specific means of delivering the settlement. For instance, the originator can request a check sent from one party to another, a financial adjustment off of a future remittance retraction e.g., and electronic payment, a check paid through another receivable management firm, an electronic funds transfer, or other types of resolutions. The workflow for claims can also be managed internally to a single organization prior to a claim dispute being generated and sent to a recipient.

It should also be noted that at a high level, all claims in the resolution system are either resolved or unresolved. Resolved claims are those that have either been agreed to and either reconciled or denied. Unresolved claims include new referrals and any claims that are pending or unreconciled. At a more detailed level within the system of the present invention, a field of data is maintained with each claim dispute record. Based on actions and the state of the claim, the present system attaches a status indicator to referred claims. This status indicator notifies the end user of the claims location within the system's claim resolution process. For instance, the status may read “new referral”, “pending accepted”, “pending denied”, “pending disagreed”, “pending agreed”, or the like. The final, concluding status is known as an end state (e.g., the claim is resolved/reconciled; resolved/denied; closed/cancelled; resolved/closed). Finally, a work queue will be a computer-generated graphical indicator that notifies an end user as to the location of claims groups wherein the groupings are based on a review of the claim(s), actions needed on the claims, or the status of the claims.

A claim, or claim dispute, in connection with the present system, is envisioned as a post-adjudication, post-payment claim. Typically, this means that the payer has previously decided whether, and how much, payment should be made to the provider. The claim dispute then revolves around one party identifying an incorrect or improper payment. The invention could be incorporated into or further comprise a pre-adjudication, pre-payment system. In an envisioned embodiment the system can also be used to answer questions about a pre-adjudicated or pre-processed claims to document and resolve issues before the claim is paid, preventing future discrepancies. In one preferred embodiment, a claim dispute will relate to an organization's internal work flow of identifying an errant claim, communicating the claim, and/or interacting with the claim within the resolution system. In any event, the general nomenclature, including the terms status indicator, end state, actions or process steps, is not intended to be limiting. The defined terms merely facilitate understanding of the present invention, and it is readily apparent to one skilled in the art that the various components may be known by other terms.

The automated resolution system of the present invention, including all process steps and actions, exist within an electronic environment, although it envisioned that certain aspects of resolving a claim may still involve non-electronic communication, including, but not limited to, filing of statutorily required documents. The resolution system provides a claim dispute portal, which is, in one preferred embodiment, a website accessed by the parties to the claim dispute. The website can be created using known website construction techniques. The portal could also be embodied as a client server application or other electronic exchange medium known to one skilled in the art. Effectively, the portal is a simulated “room” where parties place their knowledge of a claim dispute “on the table.” The language to resolve the dispute is restricted to choices offered by the system-created portal. The customizable view, discussed above, may also limit actions available to the user. Different views and work lists can be assigned to multiple organizational departments or users within a department at any of the parties' locations. The claim is accessible by multiple users for different reasons. For instance, an administrator of the present situation may access a claim in order to provide technical support. A work list drives the account resolution process through a series of resolution action codes.

The portal is shared between the resolution system users via a communication vehicle that is based on a secure communications media, be it the internet, a virtual private network (“VPN”), or the like. Interaction will generally occur over a browser-based connection (i.e., Internet, Intranet or Extranet) and will, therefore, have inherent security measures that meet HIPAA standards. In a preferred embodiment, the communication protocol presents a real time (or instantaneous) exchange, though non-real time communication support is envisioned for the resolution system. Other suitable communications modes exist and are obvious to one skilled in the art.

In addition to the inherent security measures, the system provides pre-populated client specific federal, state and local compliance letters or forms based upon information stored in the system database. These documents can be viewed electronically via the portal or can be printed, mailed, emailed, faxed, etc. The documents are also attached to the claim record and dynamically reflect the most current information within a claim record.

The system tracks a claim dispute within a claim form. In other words, every action that is performed that affects the claim is automatically recorded within the system using known data storage techniques. The system documents the time of the action, the date on which the action occurred, the name of the user initiating the action, the name of the action as it defined with the system, and other pertinent data. The stored or recorded information is viewable by any party with access to that claim. One skilled in the art will appreciate that various information about the action can be recorded or presented as determined by the system users.

For the purposes of documentation, review, and analysis, all claim information, responses, actions, and status changes are stored whether the change or performance is initiated by the claim originator, claim recipient, an internal review, a system administrator, or the like. This revised claim-specific information added by any entity is appended to the original claim record with a time and date stamp. Accordingly, the claim originator begins a new record by referring a claim to the claim recipient. The time, date, and referring party are stamped into the dispute record. The claim recipient's response is, in turn, appended to the original record. The originator's action and response is also appended to the original record. The communication process continues until the parties reconcile the account. All recorded communication and stamps are accessible at all times to any entity with access to the claim, although it is envisioned that access might be limited where statutory regulation or contractual obligations require it. The current status of the claim is noted as well as the actions that need to take place prior to triggering the next status change. Effectively, all actions and system notes are recorded in a historical audit trail that cannot be changed, and the historical claim record can be viewed by all parties for a full historical documentation of the claim resolution.

The system also stores applicable statutory requirements in the system database. The requirements are imposed on claims records in the claim inventory. Tracking individual claims and incorporating the governing local, state, and federal laws related to healthcare claims, facilitates compliance with those laws. The date stamps will record the transaction and communication while the system can be customized to account for relevant laws based on location. Relevant laws typically impose mandated timelines for payment, timely overpayment recovery, and other general healthcare claim resolution requirements. Claims that are not in compliance based on the tracking information are flagged, grouped, or otherwise highlighted for attention by the relevant claim participants.

Moreover, the present invention can accommodate individual claim entry as well as batch processing. The post adjudication and post payment data from the provider and payer is incorporated into an electronic dispute file. It is also envisioned that the resolution system might communicate with a prepayment, pre-adjudication system in order to automatically incorporate pertinent information regarding the claim dispute. Once the resolution system receives the raw data from the provider, payer, and/or automated prepayment system, a receipt notice is automatically confirmed and the claim status is updated. Communications are secured through a provider/payer network, which is agreed upon by each provider and payer. The provider and payer have the ability to add or eliminate contacts within the electronic portal in order to specify with whom they will communicate for the purpose of a claim resolution (subject to statutory regulations).

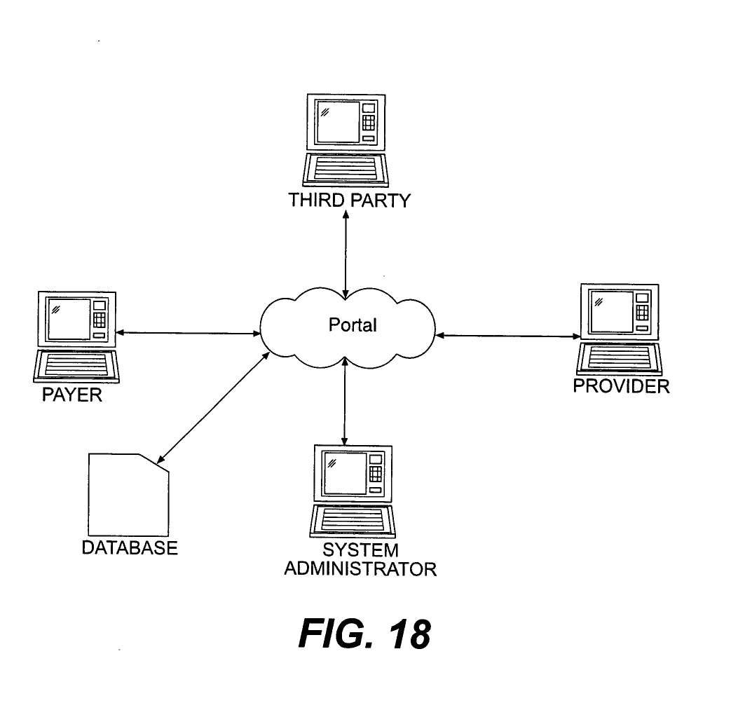

Turning to the present invention, FIG. 18 supplies a global view of the present invention wherein a number of parties are optionally connected to a portal. The individual elements are clearly labeled in FIG. 18 so that it is thought to be self-explanatory. More specifically, a claim dispute is created to be stored in a database that is in two-way communication with the portal. A single party, typically either the payer or provider, may access the portal to manage in-house work flow related to a claim. Any modifications or proposed settlements related to the claim are shared with other parties. A system administrator could be granted access to the system to resolve technical or other issues within the system. In this regard, it may be necessary for the administrator to access the portal and specific claims records (subject to applicable laws). It is also envisioned that parties may selectively grant access to optional, allowable and/or required third-party participants. Overall, the portal provides predefined and/or customizable views of data stored in the database. Predefined and/or customizable actions will be supplied in the portal that facilitates the resolution of the claim dispute.

It is envisioned that each party will have full and equal access, and ability to append the claim record. However, it is also understood that a system administrator or third-party participant might not have equal access to a claim record based upon applicable statutes or contractual agreements between the parties. For example, the primary parties, specifically the payer and provider, might agree that certain information will not be available. The system of the present invention will store these contractual requirements in the database and use the information to dictate the information, views or options available to each party based on the stored requirements. It is possible to customize the view, information and options available to each party.

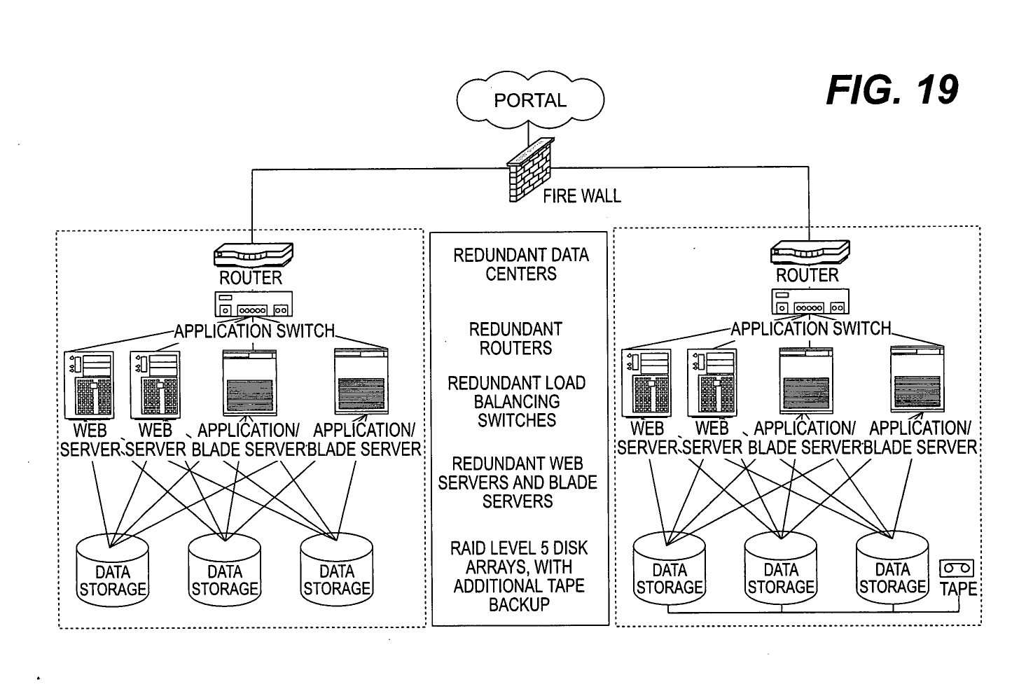

The system of the present invention includes an electronic infrastructure that provides for the two-way communication of data between the database and portal. In one preferred infrastructure, as illustrated in FIG. 19, there is an optional firewall between the portal and electronic infrastructure. In the illustrated example, a first database and a second database are provided with the secondary database acting as a backup in case of a system failure in the first database and vice-versa. The general infrastructure is known in the prior art. Basically, incoming data is sent through a router to an application switch that distributes the data to a plurality of servers. Each server includes or is in communication with known data storage hardware. As will be appreciated by one skilled in the art, the infrastructure to support the function of the system of the present invention can comprise any number of configurations. The infrastructure can be scaled, as discussed below, to handle more or less data load.

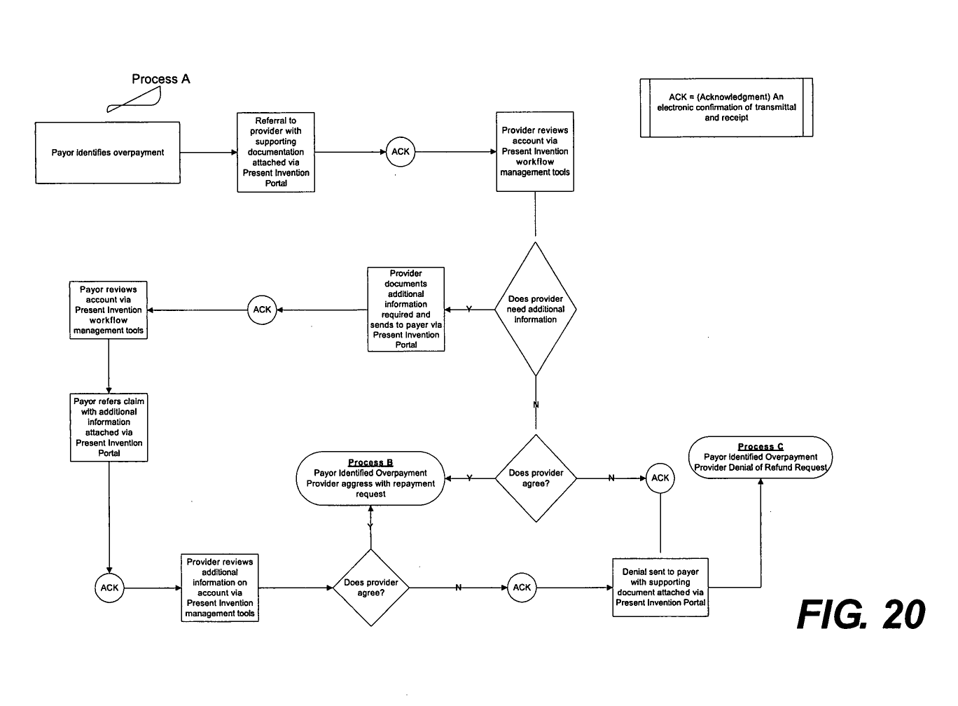

FIG. 20 illustrates a Process Step A, wherein a payer identifies and processes an overpayment in accordance with the present invention, is illustrated. It is understood that the payer, in this scenario, has previously paid a provider for services rendered, but an overpayment has been discovered. The individual elements of the process are clearly described within the flowchart so that one skilled in the art may replicate the system of the present invention. The following discussion expands upon the self-explanatory flowchart.

In Process A, the payer accesses the electronic portal of the present invention and originates a claim dispute by uploading the pertinent information to the portal or by manually entering the necessary information. The claim dispute is then referred to the provider. A status of New Referral is assigned to the claim. It is possible to associate supporting documentation, including the payment history, medical records, and the like with the generated claim record. In a preferred embodiment, the claim originator must supply the required claim information as well as a proposed settlement. In another preferred embodiment, the originator's view of the portal would include a “Refer a Claim” icon or button. A new referral wizard prompts the claim originator for information regarding the claim recipient, claim information, proposed settlement, or other pertinent data. This effectively creates a “one-click” referral process.

The claim is assigned to a recipient for the provider who reviews the claim dispute. The review action automatically generates an electronic confirmation of transmittal and receipt, known as an acknowledgment. In reviewing the claim dispute, the provider may review the account via the workflow management system provided by the present invention (see Process H in FIG. 27).

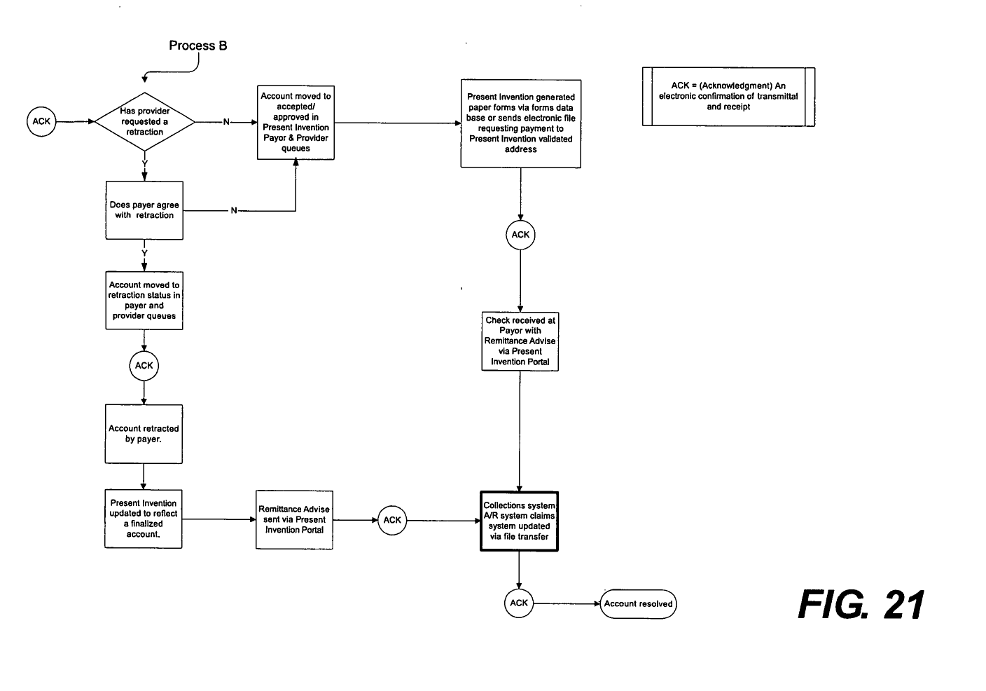

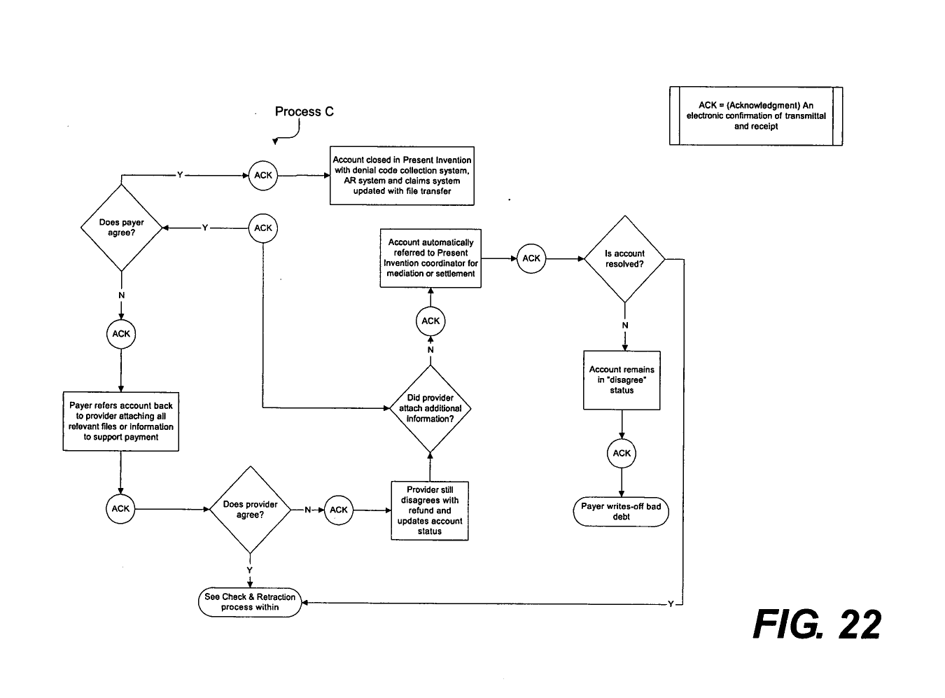

The provider acts to move the process forward. Therefore, the provider's actions consist of either requesting additional information from the payer or making a decision on the claim. In the event that the provider agrees with the claim, Process Step A is completed and the claim enters Process Step B, as illustrated in FIG. 21. If the provider disagrees, the denial is communicated to the payer and the claim moves to a new process step (see Process C in FIG. 22). The claim recipient may acknowledge that a settlement should be made but in a differing amount. The recipient can propose the new settlement amount. Settlement figures are negotiable during pendency of the claim. An electronic record is created for each proposed settlement.

The provider can choose to request additional information before making a decision by documenting within the resolution system the information that is needed to make a decision. The payer acknowledges the documented information request. The payer reviews the account via the resolution system and any applicable work flow management tools provided by the system. The additional information is referred back to the provider via the portal for acknowledgment. This information can be exchanged or appended in a claim record in the form of electronic documents including, but not limited to, images, PDF files, spreadsheets, medical records, and the like. An “Add Document” button accesses this feature. In this scenario, the provider can then review the claim and make a decision as described above.

Prompts are given to the users based on a claim's status and further based on their transacting partner's action. Status changes occur after the appropriate actions are taken, as defined by the system. The system changes or retains the status of the claim until the claim reaches a reconciled status. Settlement of the claim can be proposed at any point of the claim's life, but the respondent must agree to the settlement. Once a settlement is reached, the system “promotes” the status of the claim and handles financial transaction information. With the financial transaction is completed, the system will again promote the status of the claim to a resolved status.

Process B in FIG. 21 illustrates the process that develops after Process A, when the provider agrees that the payer has submitted an overpayment. The provider electronically acknowledges that a review of the claim has been completed. In the first action, the provider may request a retraction of the claim's disputed amount. A retraction occurs where a payer offsets a specified dollar amount from a different patient's claim that they believe to be overpaid. A retraction request causes the claim to be identified with a retraction status in the payer and provider work queues. The change in status is acknowledged. The system updates the claim to reflect a finalized account, and advice concerning the pending transfer of funds is made available to the parties in the shared portal. After an acknowledgment, a collections and/or accounts receivable system is updated via file transfer. The file transfer occurs via known file transfer protocols. Receipt is acknowledged and the account is progressed to an end state where further actions are unavailable.

The provider may choose to not request a retraction within Process B. In this event, the account moves directly to an accepted/approved status in the payer and provider queues. The resolution system generates forms by means of data stored in a database. Physical and/or electronic forms are delivered to, and acknowledged by, the provider. The provider remits the overpaid money to the payer and the account is closed.

Process C illustrates a process step following Process A whereby the payer identified overpayment and repayment request has been denied by the provider. Upon review of the denial and any supporting documentation, as delivered by the system, the payer can agree with the denial. The agreement is acknowledged to the provider, and the account is closed with a denial code. The pertinent collection and accounts receivable system are updated.

As clearly illustrated in FIG. 22, the provider's initial action in Process C may be to contest the denial of a repayment. This decision and additional documentation is sent to the provider for a second review. The provider, upon further review, can agree with the payer in which case the claim moves to a Check and Retraction process. This process is identified as Process H in FIG. 27.

On the other hand, the provider can continue to disagree with the payer. The provider can attach more information in support of that action, in which case the initial actions of Process C are repeated. If no additional information is forthcoming, however, the account is automatically referred via the system to a coordinator for mediation or settlement. The third-party mediation system is not described herein, but the automatic referral action progresses the claim. A successful mediation or settlement concludes Process C and the process of Check and Retraction (Process H) begins. An unsuccessful mediation or settlement means the payer has to write-off the overpayment as bad or unrecoverable debt.

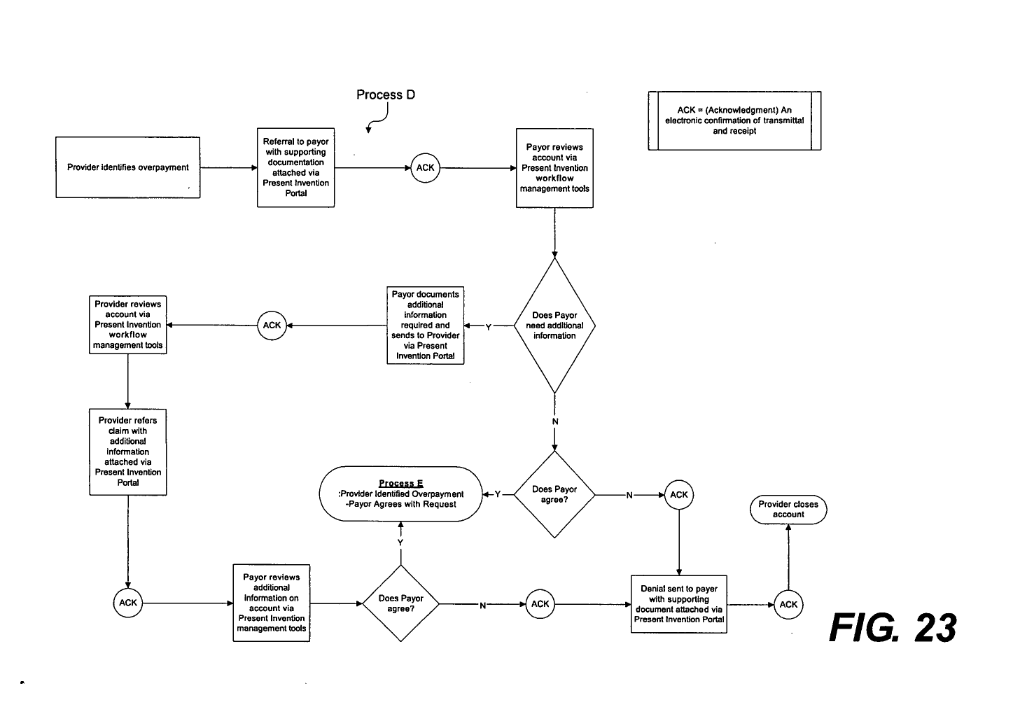

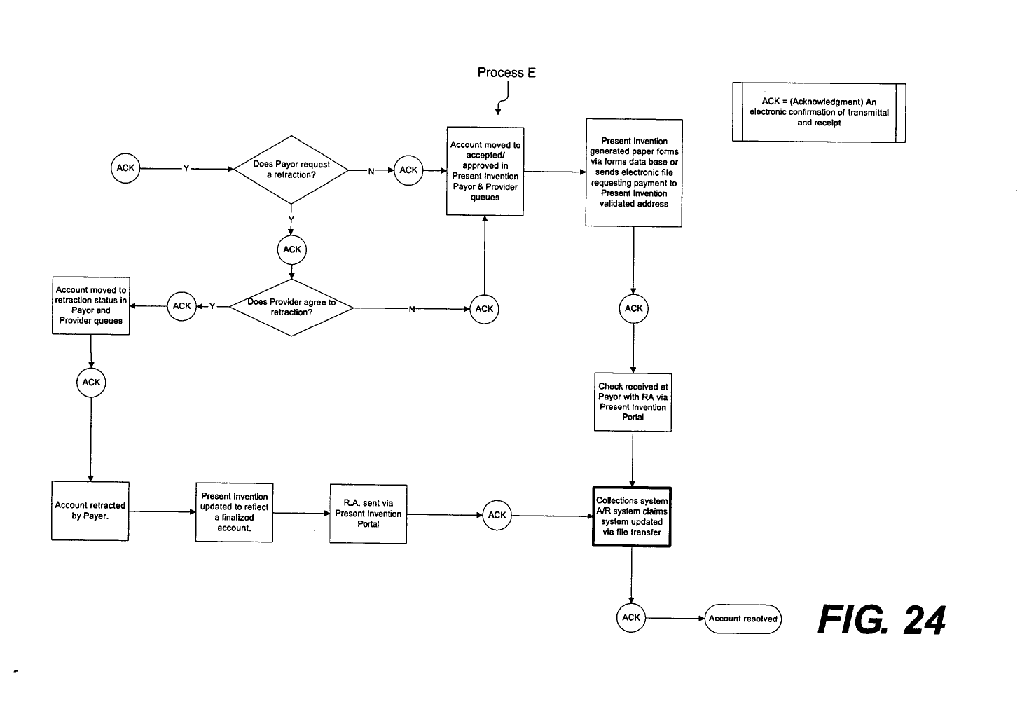

It is also known that a provider can identify an overpayment in a post-payment, post-adjudication environment, as clearly illustrated in FIGS. 23 and 24 and labeled as Processes D and E, respectively. These two processes operate, in many respects, like Processes A and B. Given the earlier discussion and clearly labeled elements, the illustrations are thought to be self-explanatory to one skilled in the art.

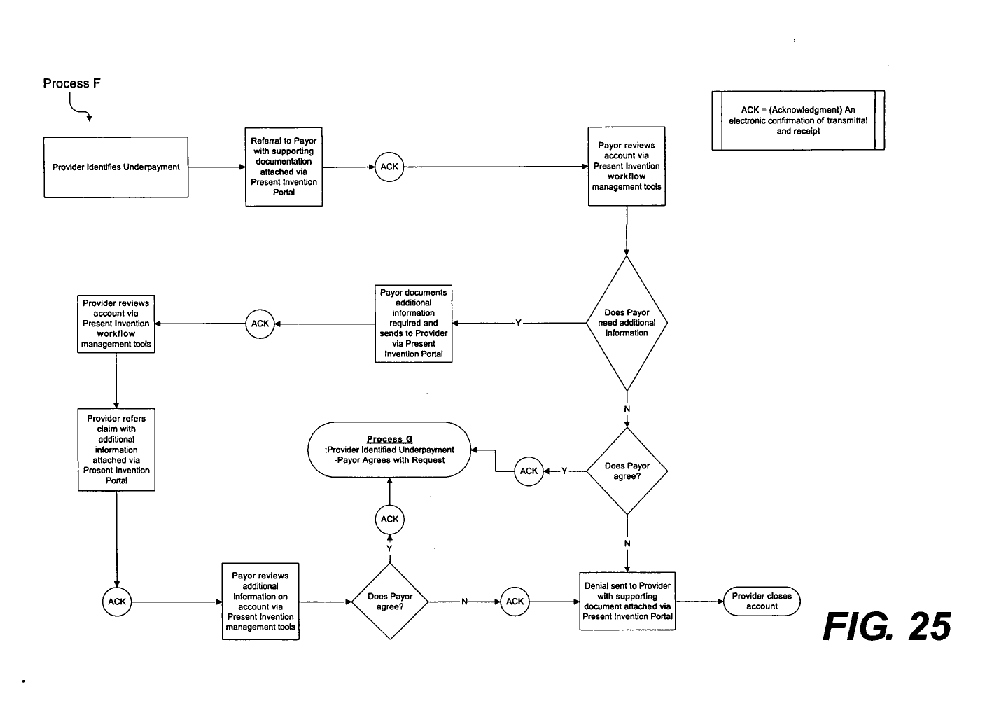

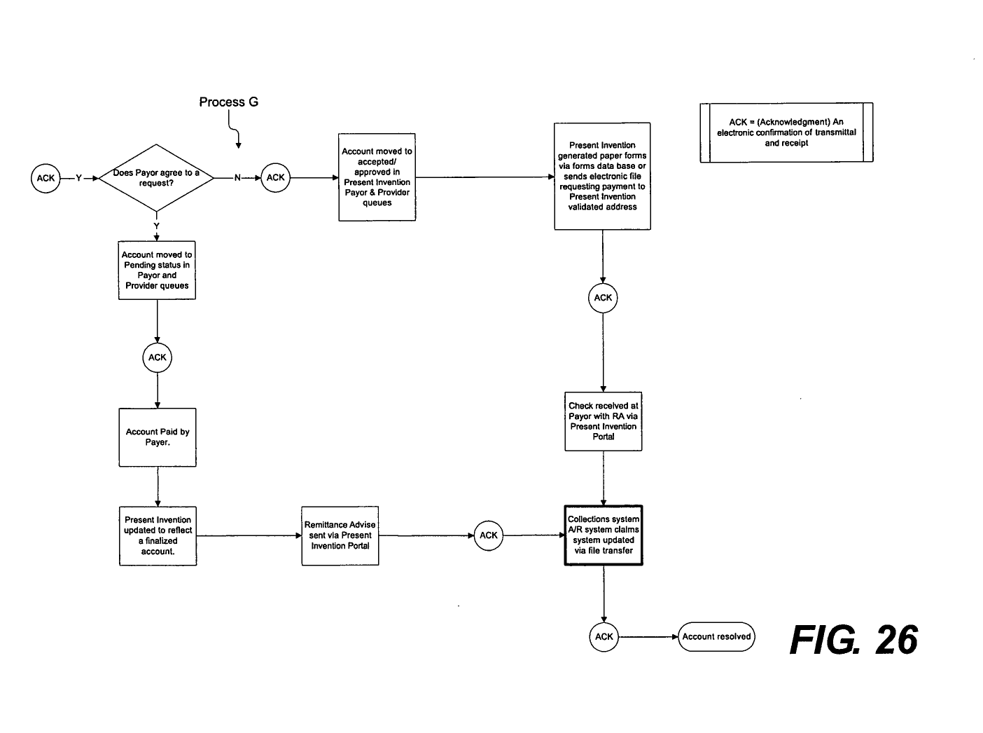

In Process F, a provider has identified an underpayment and takes action to create and refer a claim dispute to the payer with supporting documentation. Process G occurs when the payer agrees with the provider's assessment of the claim. Again, the elements or actions are identified so that the processes are clearly defined in FIGS. 25 and 26 Process F parallels the actions available in Processes A and D where overpayments were identified by the payer and provider, respectively. Process F varies in that an underpayment has been made. Likewise, Process G is substantially the same as Processes B and E. The originator and receiving parties vary according to the type of process but the available actions are mainly consistent.

The above processes demonstrate how the automated system of the present invention moves a claim from origination to resolution. However, the illustrated processes are not inclusive of all potential actions. For instance, third parties may interact or track claim disputes. The system infrastructure and software programming does provide a secure and private communication vehicle that allows all participating parties to track and interact with a claim. In a preferred embodiment, the environment would be entirely electronic. It is also envisioned that certain information, forms, documents or the like may be delivered as physical “hard copies”. It is also envisioned that a payer, provider, or third party can set access rights to the claim dispute thereby permitting or excluding additional parties. Third party participants may be required under the law, may be helpful to the resolution of the claim, may have a legal or monetary interest in the claim dispute resolution, and the like.

The above processes illustrate potential interactions between parties through the system, but the resolution system may also operate as a detailed workflow management system. In FIG. 27, a Process H, briefly mentioned above, provides one embodiment of a provider workflow management system. The flowchart provides a self-explanatory enablement of the workflow system. Basically, the provider identifies a claim that needs further processing or correction after a payment and adjudication. A claims processor enters the claim data into a claim data field provided by the present invention. Additional information could be incorporated from other electronic programs. The claims processor indicates the reason for the claim (e.g., provider or payer identified overpayment/underpayment). A new referral is created and is accessible by the payer. The payer can accept the claim, in which case the account is reconciled and closed. If the payer disagrees, the claim is assigned to a work queue such as the provider's “Pending” work queue. The provider reviews the claim(s) labeled “Pending” at which point the system automatically assigns a new work queue and moves the claims to the payer's pending queue.

The second review either leads to acceptance, as described above. If the payer does not deny the claim, the process step loops through the work queue options. If the claim is denied, a “Denied” status is assigned. The provider can agree, which means the account is closed, or they disagree and Process H is repeated in full.

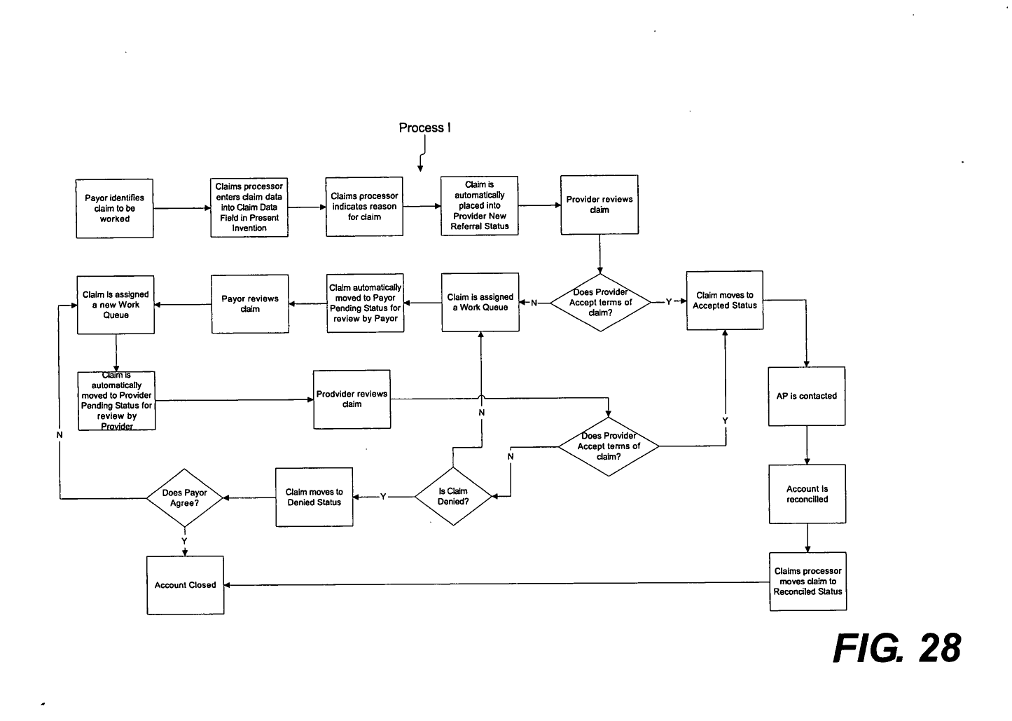

A Process I is illustrated by the flow chart of FIG. 28, which details a payer workflow process that is illustrated that is similar to the provider process illustrated in Process H. The exact participants and available actions for Processes H and I may vary from the illustrated examples without deviating from the scope of the claims. Overall, the system dictates the claim resolution workflow process by identifying the claim type as overpaid, underpaid, etc. and then applying an appropriate internal workflow resolution process.

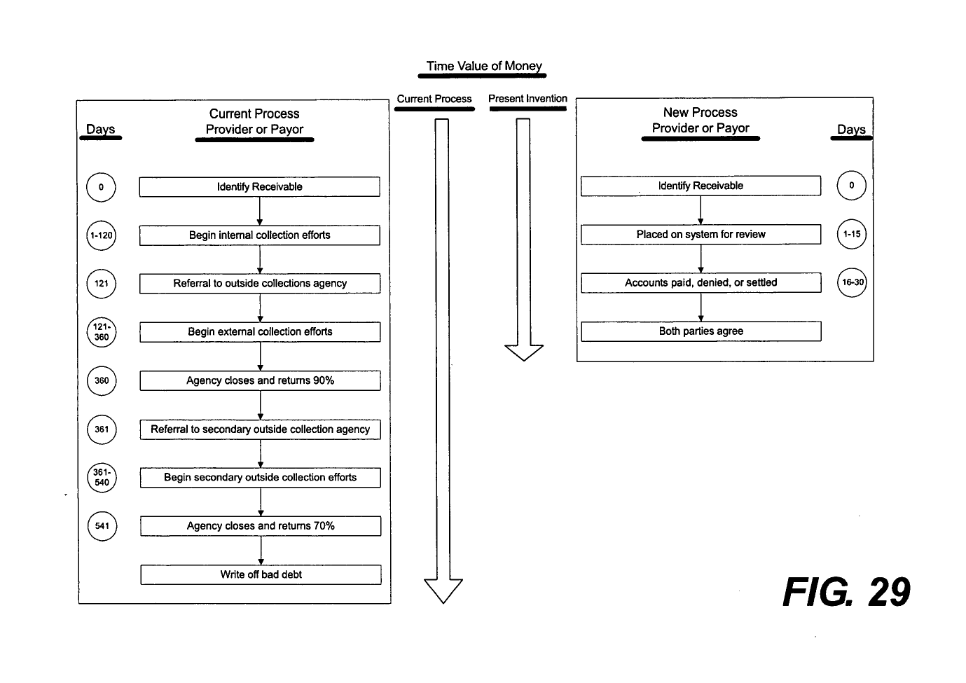

FIG. 29 compares and contrasts a typical claim dispute including the inherent inefficiencies resulting from manual operations/non-conforming systems to the process of the present invention. Assuming, in both cases, that the claim is disputed throughout the process, the old technique is estimated to take, in some instances, almost two years to resolve a claim. The resolution system of the present invention facilitates communication and provides a shared environment to interact with the claim. In a preferred embodiment, the resolution of the claim takes about two months and both parties have full access to all supporting documentation in order to understand the basis of the final decision or resolution.

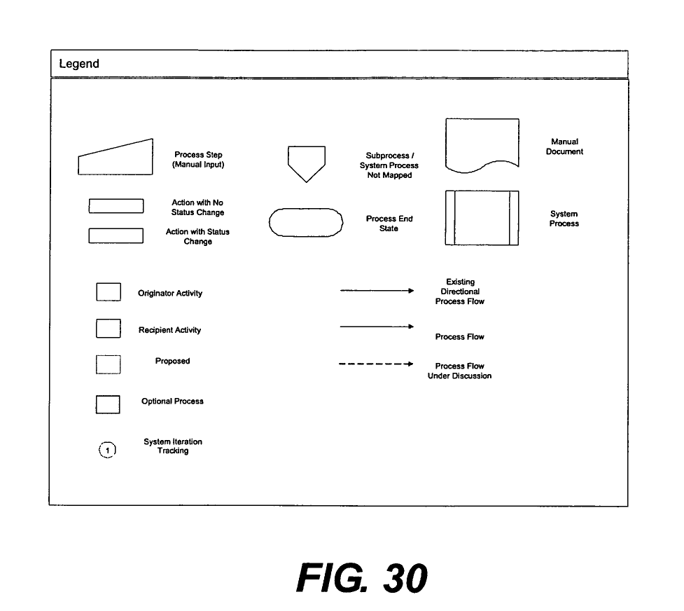

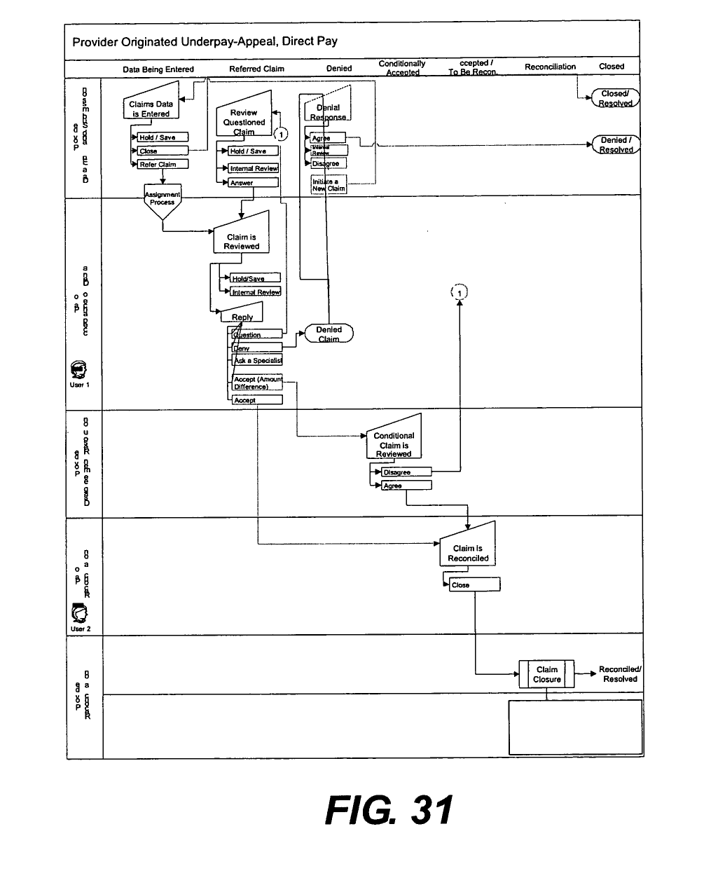

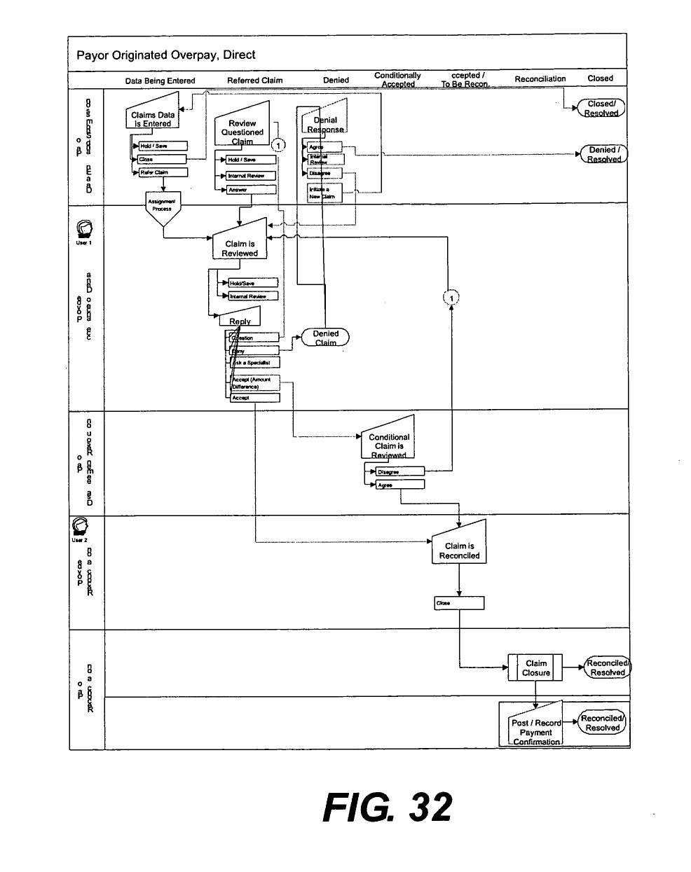

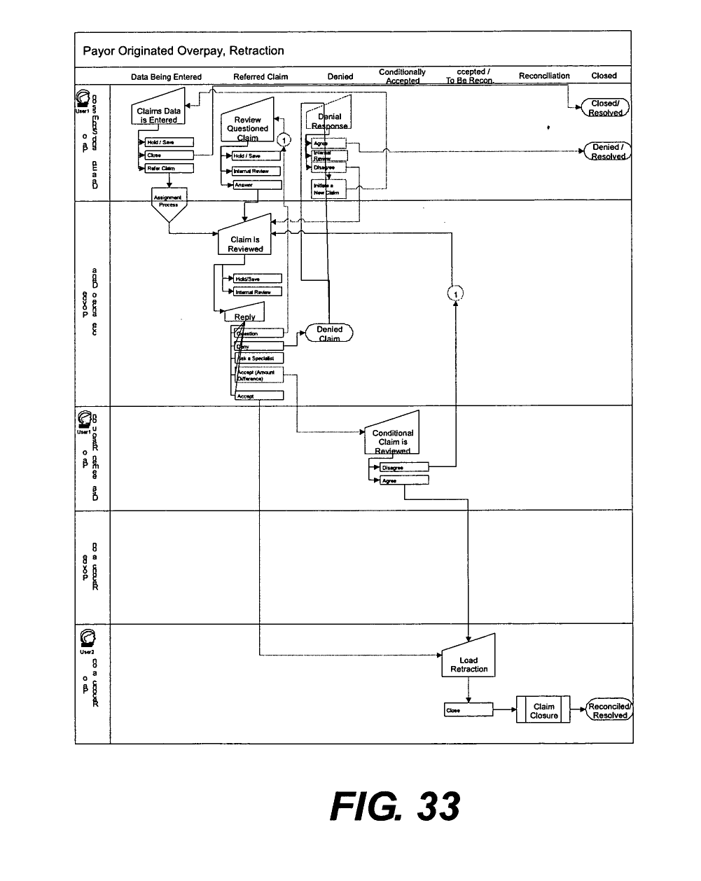

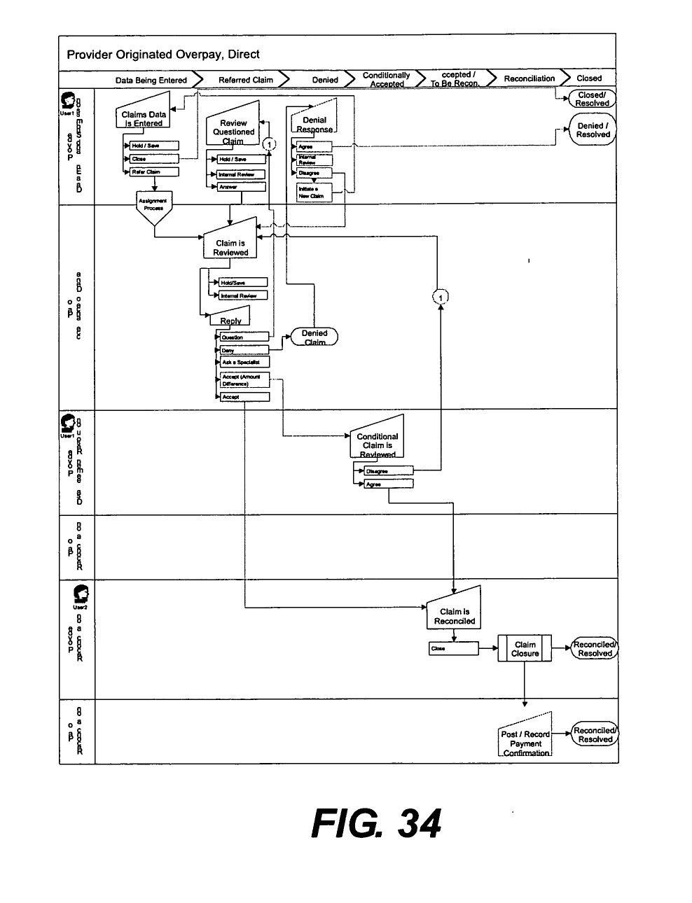

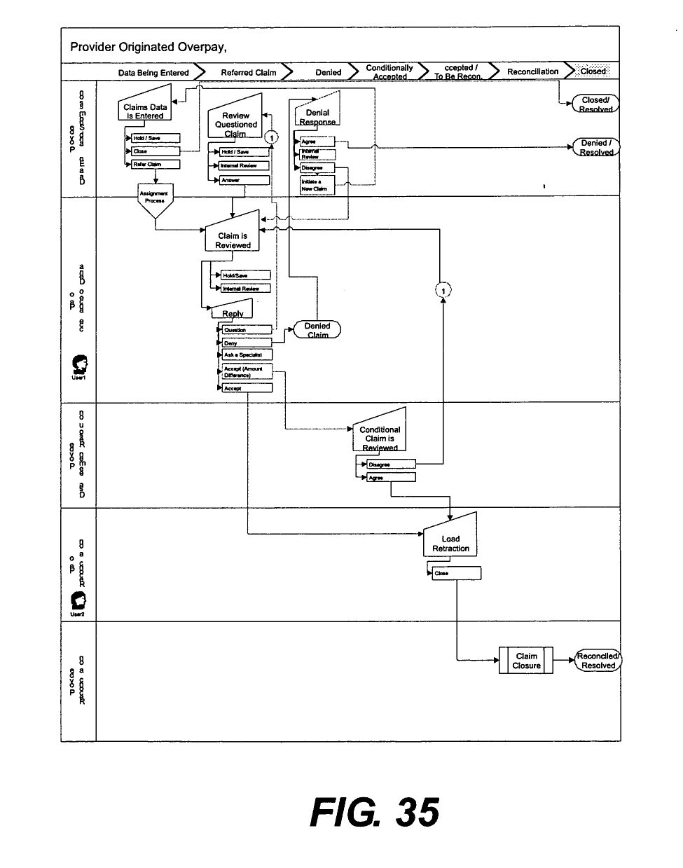

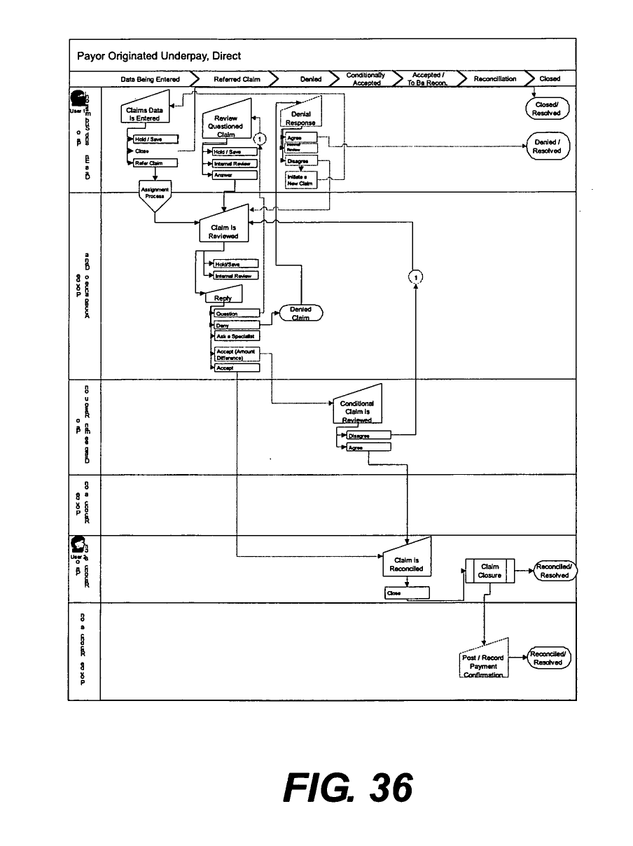

FIG. 30 provides a legend for understanding FIGS. 31-36. FIGS. 31-36 illustrate action/options of the present invention in further detail. The steps are grouped to the party taking an action and cross-classified to the status of the claim. For instance, in FIG. 31, a provider identifies an underpayment. The initial process step of entering the claims data is placed in the row labeled “Provider Data Entry and Submission” and under the status of “Data being Entered”. The actions available at that point of the process step are labeled.

As clearly illustrated, one available action is to refer the claim to the payer. In that event, the process step of claim review is initiated. This process step is located within the row “Payer Acceptance or Denial” and column “Referred Claim”. The labeling and legend explain to one skilled in the art a preferred embodiment of the present invention. The self-explanatory and fully enabling flow charts illustrate at least one preferred embodiment of the present invention and do require additional discussion herein.

As a result of storing each claim and documents, actions, status changes, and the like associated with the claim, parties can create standard and customized reporting. Every claim can be associated to specific parties since each claim is stored in a database. Claims associated to a party form that parties' claim inventory. A user, therefore, has the ability to view the claim inventory for specific partners. The claim inventory information can be presented in various formats to establish trends and benchmarks with a user's partner's inventory. Inventories for multiple partners can be compared, which helps to track the performance of the user's partners. Maintaining an inventory also allows a user to analyze statutory due dates, as described above. The inventories can be accessed to monitor compliance with all relevant laws.

Interactions between the parties can also be controlled by a rules and/or glossary section of the system's database. The rules would be based on contractual agreements between the parties. Each payer subscribed to the portal would likely have different healthcare benefit policies. These policies would be accessible from the claim record to clarify a billing or payment dispute. In preferred embodiment, these policies are agreed to before or during the referral of the claim so that the policies dictate the mechanisms for resolving the claim such as settlement language, available actions, and the like. The document would be stored in or linked to the claim record so that either party could review contract payment and administrative guidelines during pendency of the claim. The contract upload date and respective parties' signatures will be available to assure validity and accuracy.

Bringing together the contractual guidelines, workflow guidelines, relevant laws, and tracking abilities provides a system that also has the ability to analyze and score all claims, determine work queue assignments, identify additional financial opportunities, and generally provide a more comprehensive overview of all claims activity for any one provider or payer. Queries are then conducted to identify errors. System queries are conducted by the system itself to analyze historical claims or through the system administrator. Problem claims can be identified based upon error analysis, settlement thresholds, non-compliance with applicable laws, or other predetermined qualifying factors. The system queries operate continuously, or near continuously, as an automated background process and filter for all new referral claims. User's can launch specific or ad-hoc queries, too. These queries, when used in conjunction with the contract information, workflow rules, and relevant laws will identify and group problem claims within a client's claim inventory.

Although the present invention has been described in terms of a preferred embodiment, it will be understood that numerous variations and modifications may be made without departing from the invention. Such variations and modifications will become apparent and obvious to one skilled in the art, and all equivalent relationships to those illustrated in the drawings and described in the specification are intended to be encompassed by the present invention. Accordingly, the system could be expanded to case management that would automatically move a case from doctor referral to completion, including reconciling claims related to the case. Other embodiments are intended to be covered by the scope of the invention. Thus, it is to be understood that within the scope of the appended claims, the invention may be practiced otherwise than as specifically described above.

What is claimed is:

1. A method for resolving healthcare claims, the method comprising the steps of:
providing an electronic portal to be accessed by at least a first end user;
referring a claim dispute to be viewed as a claim dispute record via the portal;
maintaining a secure private environment for communication between any claim resolution participants and for accessing the portal;
transmitting the claim dispute record and end user communication via the electronic portal to at least a second end user;
tracking the claim dispute.

2. The method of claim 1, further comprising the step of storing the claim dispute record in a claim dispute inventory.

3. The method of claim 1, further comprising the step of promoting the claim dispute record through a hierarchy of pre-defined statuses.

4. The method of claim 1, wherein the step of tracking the claim dispute record includes stamping the record with time and date indicators.

5. The method of claim 1, further comprising the step of stamping a claim dispute record to record actions enacted on the claim dispute.

6. The method of claim 1, wherein the step of tracking the claim dispute further comprises the step of recording both modifications to the claim dispute record and identification information for the user making the modifications.

7. The method of claim 1, further comprising the step of restricting access to the portal to authorized end users.

8. The method of claim 1, further comprising the step of storing information concerning a claim dispute in a database, the database being accessible in real-time to parties with access to the portal.

9. The method of claim 1, wherein the step of transmitting a claim dispute record via the portal includes transmissions to at least one third-party participant.

10. The method of claim 1, further comprising the step of defining allowable actions in a claim dispute.

11. The method of claim 10, further comprises the step of stamping the claim dispute record when an end user selects at least one of the defined actions.

12. The method of claim 11, further comprising the step of identifying in the claim dispute record the end user acting in the claim dispute.

13. The method of claim 10, further comprising the step of incorporating a rules and glossary appendage to a claim dispute record, the appendage at least partially dictating actions allowed by the various end users.

14. The method of claim 1, further comprising the step of customizing a view of the claim dispute record that is displayed via the portal.

15. The method of claim 14, wherein the view of the claim dispute record is customized to account for contractual agreements between at least the first and second end users.

16. The method of claim 14, wherein the view of the claim dispute record is customized to account for the role of the end user viewing the dispute record.

17. The method of claim 1, further comprising the step of appending electronic document images to a claim dispute record, the documentation being accessible via the portal.

18. The method of claim 1, further comprising the step of copying to a claim dispute record identities of all third parties working on the subject claim dispute.

19. The method of claim 1, wherein the portal provides a location for a claim record to be viewed with full disclosure of the claim record to each end user involved in the claim dispute.

20. The method of claim 1, further comprising the step of settling a claim dispute by forwarding information in support of a settlement offer via the portal between at least first and second end users.

21. The method of claim 20, further comprising the step allowing a second end user to modify a forwarded settlement offer, said modified offer viewable by each end user via the portal.

22. The method of claim 1, further comprising the step of automatically populating legal documents related to a claim dispute with the documents to be shared by multiple end users.

23. The method of claim 1, further comprising reporting and analyzing data from the disputed claim inventory.

24. A method for resolving healthcare claims, the method comprising the steps of:
providing an electronic portal to be accessed by end users;
creating at least one claim dispute record in a claim dispute inventory database, said inventory and said claim dispute record viewable via the portal;
forwarding that claim to an identified individual at a third party for resolution;
verifying receipt of claim by third party;
accessing the portal using secure electronic communication;
progressing the claim dispute record through a hierarchy of pre-defined statuses when the one or more users select predefined actions displayed by the portal; and
tracking the claim dispute record.

25. The method of claim 24, further comprising the step stamping the record with time and date indicators when the one or more users select an action.

26. The method of claim 24, further comprising the step of recording user selected actions and the identity of the user taking the selection action in the claim dispute record.

27. The method of claim 24, further comprising the step of restricting access to the portal to authorized end users.

28. The method of claim 24, further comprising the step of customizing a view of the claim dispute record that is displayed via the portal.

29. The method of claim 28, wherein the view of the claim dispute record is customized to account for contractual agreements between at least first and second end users.

30. The method of claim 28, wherein the view of the claim dispute record is customized to account for the role of the end user viewing the dispute record.

31. The method of claim 24, further comprising the step of appending electronic documentation to a claim dispute record, the documentation being accessible via the portal.

32. The method of claim 24, wherein the portal provides a location for a claim record to be viewed with full disclosure of the claim record to each end user involved in the claim dispute.

33. The method of claim 24, further comprising the step of settling a claim dispute by forwarding information in support of a settlement offer via the portal from a first end user to a second end user.

34. The method of claim 33, further comprising the step of allowing an end user to modify the settlement offer, said modified offer viewable by end users via the portal.

35. A system for resolving healthcare claims, the system comprising:
an electronic portal,
a database connected to said portal,
at least one computer in electrical connection with said electronic portal,
a claims record stored in said database to be viewed via said portal, and
wherein said at least one computer provides views and action options to an end user so that said claims record is viewable and modifiable via said views and options in said portal.

36. The system of claim 35, further comprising a claim dispute inventory containing multiple claims records.

37. The system of claim 36, further comprising a report based upon information stored in said claim dispute inventory.

38. The system of claim 35, further comprising date and time stamps placed within a claims record when a claim record is modified using said pre-defined options.

39. The system of claim 37, further comprising an identification stamp in the claim dispute record that contains identification information for the end user acting in the claim dispute.

40. The system of claim 35, wherein said database contains a rules and glossary appendage to a claim dispute record, the appendage at least partially dictating actions allowed by the various end users.

41. The system of claim 35, wherein said view comprises a customizable view of the claim dispute record that is displayed via the portal.

42. The system of claim 41, wherein the view of the claim dispute record is customized to account for the role of the end user viewing the dispute record.

43. The system of claim 35, further comprising appendices stored in said database, said appendices including electronic documentation related to a specific claim dispute record, said documentation being accessible via the portal.

44. The system of claim 35, further comprising statutory rules stored in said database, said statutory rules being applicable to one or more claim dispute records, said statutory rules being accessible via the portal.
